(19) United States
(12) Patent Application Publication
(10) Pub. No.: US 2024/0077017 A1
(43) Pub. Date: Mar. 7, 2024

(54) OXY-FUEL POWER GENERATION AND OPTIONAL CARBON DIOXIDE SEQUESTRATION

(71) Applicant: Tigre Technologies Limited, Fleckney Leicestershire (GB)

(72) Inventors: Robert Austin Hastings, Fleckney Leicestershire (GB); Alison Dawn Hastings, Fleckney Leicestershire (GB)

(21) Appl. No.: 18/261,240

(22) PCT Filed: Jan. 12, 2022
(86) PCT No.: PCT/GB2022/050062

§ 371 Date: Jul. 12, 2023

(30) Foreign Application Priority Data
Jan. 14, 2021 (GB) 2100459.3
Jan. 14, 2021 (GB) 2100460.1

(51) Int. Cl. F02C 3/34; B01D 5/00; B01D 53/26; F01K 19/00; F01K 21/04

(52) U.S. Cl. CPC F02C 3/34; B01D 5/0003; B01D 5/0039; B01D 5/0054; B01D 53/265; F01K 19/00; F01K 21/047; B01D 2256/22; B01D 2257/504; B01D 2257/80; B01D 2258/0283; F05D 2220/76; F05D 2260/611

(57) ABSTRACT

There are disclosed systems and methods for generating electrical power from oxy-fuel combustion in a turbine system. The turbine system makes use of recycled steam as a components of the turbine working fluid. Also disclosed is an integrated recuperator and separator, which may be used with the turbine system, configured to separate water and carbon dioxide from exhaust fluids from the turbine system, heat from the exhaust fluids being used to generate steam from the separated water for recycling to the turbine system. Carbon dioxide separated from the exhaust fluids is condensed to a liquid or supercritical phase and sequestered in a subsurface natural gas reservoir from which natural gas fuel for the turbine system is extracted.

The present disclosure relates to methods and systems for oxy-fuel power generation.

The present disclosure also relates to a closed circuit system and method for extraction of natural gas from a subsurface reservoir, generation of power using the extracted natural gas, and sequestration of carbon dioxide back into the subsurface reservoir.

### BACKGROUND

The use of natural gas as a fuel in gas turbine power plants is well-established. In known gas turbine systems, a gaseous oxidant (typically air) is pressurised in a compressor and fed to a combustion chamber. A fuel (typically natural gas, which is primarily methane) is injected into the combustion chamber where it mixes with the pressurised oxidant and combusted at a high temperature. The combustion process produces a high temperature, high pressure exhaust gas stream that enters and expands into a turbine section of the turbine system. As the hot combustion gas expands through the turbine section, it causes rotation of typically several sets of turbine rotors. The rotation of the turbine rotors is used to spin an electromagnetic generator in order to generate electricity. In addition, rotation of the turbine rotors also drives the compressor to draw more pressurised oxidant into the combustion chamber.

However, it will be appreciated that the efficiency of known gas turbine generators leaves room for improvement. For example, a substantial amount of energy from the expansion of the hot combustion gas is used to drive the rotors of the compressor, rather than being converted to electrical energy. Moreover, compression of gaseous oxidant by a compressor is a relatively inefficient process.

A further drawback of known gas turbine power plants is that combustion using air as an oxidant results in exhaust products containing a relatively low concentration of carbon dioxide relative to nitrogen, oxygen and other gases. This can make the separation of carbon dioxide from the exhaust products difficult. Additionally, using air as an oxidant can result in the generation of NOₓ pollutants in the exhaust gas output from the gas turbine.

Accordingly, it has been proposed to use substantially pure oxygen, rather than air, as the oxidant in a gas turbine power plant. An oxy-fuel gas turbine has a number of advantages over an air-fuel gas turbine. One advantage is that oxy-fuel combustion yields exhaust gases that is rich in carbon dioxide (when the fuel is a hydrocarbon), and mixed substantially only with water in the steam phase. As such, separation of carbon dioxide from the exhaust gas mix is facilitated.

Accordingly, challenges remain in connection with improving the efficiency of such systems.

Furthermore, carbon capture and storage is becoming increasingly important in many fields in order to reduce the amount of greenhouse gases emitted into the Earth's atmosphere as a result of industrial processes and fossil fuel extraction.

Natural gas (primarily methane but commonly including varying amounts of other higher alkanes, and sometimes a small percentage of carbon dioxide, nitrogen, hydrogen sulphide, and/or helium) is well-known as a feedstock for power generation. The natural gas is typically used as a fuel in a combustion process, and heat generated by the combustion process is used to generate power. For example, electricity may be generated by using the heat to drive a turbine generator, or the natural gas may be used in a reciprocating internal combustion engine to drive a generator.

Natural gas is typically extracted from subsurface reservoirs either onshore or offshore, and is transported to an onshore gas-fired power station by a network of pipes. It is also possible to transport natural gas in tankers, in which case it is usual for the natural gas to be compressed to the liquid phase.

The combustion of natural gas generates carbon dioxide and can also generate other greenhouse gas pollutants such as NOₓ. It is known to capture the generated carbon dioxide (and optionally other pollutants) from gas-fired power stations and then to sequester the captured carbon dioxide so as to prevent its emission into the atmosphere, where it might otherwise contribute to climate change. However, the captured carbon dioxide needs to be transported from the gas-fired power station to a remote sequestration site, and the transport process can itself result in additional greenhouse emissions (e.g. if transport is by road).

It is known, for example from U.S. Pat. No. 4,664,190, to inject high pressure carbon dioxide into an oil well. The carbon dioxide is highly soluble in crude oil, and the resulting solution of carbon dioxide in crude oil has significantly lower viscosity than crude oil by itself. As a result, extraction of crude oil from the oil well is facilitated. However, because the carbon dioxide is soluble in the crude oil, it has to be separated from the crude oil after extraction, and this does not address the problem of carbon capture and storage.

It is also known, for example from Oldenburg, C. M. & Benson, S. M.; “CO₂ Injection for Enhanced Gas Production and Carbon Sequestration”; SPE International Petroleum Conference and Exhibition; Villahermosa, Mexico; 10-12 Feb. 2002, to extract natural gas from a subsurface reservoir, combust the natural gas in a power plant, to compress carbon dioxide generated by the combustion of the natural gas into the liquid or supercritical phase, and to inject the liquid or supercritical phase carbon dioxide back into the subsurface reservoir for the purposes of sequestration and of facilitating natural gas extraction. The denser carbon dioxide sinks to the bottom of the reservoir and helps to re-pressurise the reservoir, thus facilitating the extraction of more natural gas. However, the Oldenburg & Benson paper does not provide adequate details as to how such a process may be implemented.

### BRIEF SUMMARY OF THE DISCLOSURE

Viewed from a first aspect, there is provided a turbine system comprising an oxy-fuel gas turbine generator comprising a combustion chamber section and an expander turbine section, a pumped liquid oxygen feed connected to the combustion chamber, a pumped liquid fuel feed connected to the combustion chamber, and a steam feed connected to the combustion chamber, wherein oxygen and fuel are injected into and combusted in the combustion chamber in the presence of steam, and exhaust fluids from the combustion chamber are expanded through the expander turbine section to drive an electrical generator, wherein water from the exhaust fluids from the expander turbine section is separated and recirculated as steam to the steam feed of the combustion chamber.

The oxy-fuel gas turbine generator of the present disclosure does not include a compressor or compression section to compress air and/or fuel prior to combustion. Instead, the combustion chamber is supplied with oxygen and fuel that have been pumped to high pressures in the liquid phase and then injected into the combustion chamber for combustion. In some embodiments, the liquid oxygen and liquid fuel may be pumped to pressures of 2 MPa (20 bar) to 7 MPa (70 bar). The temperature and pressure at injection may be chosen to achieve a stoichiometric reaction of high efficiency with combustion exhaust products at temperatures and pressures suitable for expansion through the expander turbine section so as to create mechanical energy that drives one or more electrical generators. High pressure steam is also introduced into the combustion chamber. In some embodiments, the steam may also be at a pressure of 2 MPa (20 bar) to 7 MPa (70 bar). Because the oxygen and fuel are in the liquid phase for pressurisation, they can be pumped to high pressures. Pumping liquids to high pressure with pumps is a much more efficient process than compressing gases with a compressor. Additionally, by obviating the need for a compressor driven by the expander turbine section, more of the energy from the hot exhaust gases can be converted into kinetic energy by rotating one or more turbine rotors so as to drive the electrical generator, rather than also having to drive compressor rotors.

The liquid oxygen feed may be at least 90 vol % oxygen, at least 95 vol % oxygen, or at least 98 vol % oxygen.

The addition of high pressure steam to the combustion chamber is also advantageous.

Firstly, the presence of steam helps to increase the density of the expander turbine section working fluid. A working fluid, in this context, is a fluid that primarily converts thermal energy into mechanical or kinetic energy expansion through one or more turbine rotors. In a conventional gas turbine generator, using air as an oxidant, there will be a high proportion of nitrogen in the air (typically around 78 vol %) to act as a useful component of the working fluid. However, a large amount of energy is needed to heat the nitrogen component of the working fluid, and much of this heat will be lost in the exhaust fluid if this is simply vented to atmosphere. The oxy-fuel gas turbine generator of the present disclosure does not use nitrogen as a significant component of the working fluid, but instead uses steam. The steam is recycled to the combustion chamber, thus helping to reduce heat loss and to improve efficiency.

Secondly, the presence of steam can help to reduce or manage the combustion temperature, which can be useful when oxy-fuel combustion takes place at temperatures substantially higher than conventional air-fuel combustion. This can help to keep the temperature of the exhaust fluids within a range that can be tolerated by the expander turbine section.

In some embodiments, the combustion chamber section and the expander turbine section may together define a first stage of the oxy-fuel turbine generator, and a combustion reheater section and an additional expander turbine section may be provided as a second stage of the oxy-fuel turbine generator.

The combustion reheater section is configured to introduce additional fuel (and, if required, additional oxidant) into the exhaust fluids from the expander turbine section of the first stage of the oxy-fuel turbine generator so as to enable a second stage combustion process. The second stage combustion process increases the temperature of the exhaust fluids from the expander turbine section of the first stage, but does not significantly change the pressure of the exhaust fluids. This helps to increase the enthalpy of the exhaust fluids, and allows them to be further expanded through the additional expander turbine section to rotate one or more additional turbine rotors so as to help drive the electrical generator also driven by the first stage of the oxy-fuel turbine generator, and/or to drive an additional electrical generator, while helping to avoid unwanted condensation of components of the exhaust fluid.

The combustion reheater can therefore be used to extract additional energy from the exhaust gases. The first stage combustion chamber section and expander turbine section operate on high temperature, high pressure fluid, and as such are highly efficient and allow a large amount of energy to be extracted from the fluid. However, if too much energy is extracted by expansion through the expander turbine section, some components of the fluid may condense to the liquid phase. Turbines are generally optimised either for gas phase or liquid phase operation, and do not operate efficiently with a mixture of phases. The exhaust fluids from the expander turbine section will still have a substantial amount of residual energy, being at a relatively high pressure but a lower temperature. Accordingly, reheating the exhaust fluids in a second stage combustion reheater allows the temperature of the exhaust fluids to be raised, thereby allowing a second stage expansion through an additional expander turbine section while avoiding unwanted condensation of components of the exhaust fluid from the first stage expander turbine section.

An oxy-fuel turbine generator does not have include nitrogen as a working fluid component. Accordingly, embodiments of the present disclosure use steam as a working fluid component to compensate for the absence of nitrogen. By recycling the steam, it is possible to recycle heat to the oxy-fuel turbine generator as well as increasing the mass density of the working fluid.

In a typical gas turbine generator with an air compressor, efficiency tends to be around 40% at most. By avoiding the need for an air compressor, and instead using pumped liquid oxygen and pumped liquid fuel, both at high pressure, it is possible to raise the efficiency of a turbine generator to around 75 to 80%. Using liquid oxygen and liquid fuel and pumping these to a high pressure (for example, 2 MPa (20 bar) to 7 MPa (70 bar) before vaporisation in the combustion chamber is highly efficient.

However, there is a significant energy overhead required to generate liquid oxygen. Embodiments of the present disclosure may be supplied with liquid oxygen from a cryogenic air separator. Cryogenic air separation is a convenient process for separating atmospheric air into its primary components by cooling air until it liquefies, and then performing fractional distillation to separate out the components as required. Because this is all done at very low temperature, the separated oxygen can easily be returned to the liquid phase for pumping. Although this is an energy-intensive process, when offset against the efficiency gain obtained by omitting a compressor section in the oxy-fuel turbine generator, an overall efficiency of around 45 to 50% may be achieved, which is better than the 40% efficiency obtained by a traditional gas turbine generator. Recycling steam, as described above, can help to boost the overall efficiency to around 50 to 60%.

The oxy-fuel turbine generator may be configured to use natural gas a fuel. In this case, the natural gas may be extracted from an underground natural gas reservoir. In some embodiments, the oxy-fuel turbine generator may be located above or close to the underground natural gas reservoir. This may be at an offshore or onshore location. In embodiments using natural gas as a fuel, carbon dioxide generated by way of combustion of the natural gas fuel may be separated from the exhaust fluids from the oxy-fuel turbine generator and returned to the underground reservoir for sequestration as described in more detail below. Oxy-fuel combustion of natural gas yields exhaust gases that are rich in carbon dioxide and mixed primarily only with water in the steam phase. As such, separation of carbon dioxide from the exhaust gas mixture is a simpler process that can be designed to be relatively efficient. A substantial proportion of the exhaust gas mixture is steam, which is condensable and thus facilitates separation of carbon dioxide. The latent heat energy released through condensation of the steam can be captured and reused within the cycle, rather than lost as in conventional processes where exhaust gases are discharged to atmosphere.

Alternatively, the oxy-fuel turbine generator may be configured to use hydrogen as a fuel. In these embodiments, little or no carbon dioxide is generated by combustion, and the primary product of combustion is water. The use of oxygen, rather than air, as an oxidant in the combustion process helps to avoid the generation of NOₓ, pollutants.

Alternatively, the oxy-fuel turbine generator may be configured to use hydrocarbons other than natural gas as a fuel. Carbon dioxide generated in the combustion process can be separated from the exhaust fluids and sequestered.

Using recycled water in the steam phase as a working fluid component has a number of advantages. The presence of steam in the working fluid can help to moderate temperatures in the combustion chamber and/or the combustion reheater. The presence of steam in the working fluid may increase the heat capacity of the working fluid and help to moderate temperature fluctuations. The presence of steam in the working fluid may increase the density of the working fluid, and thus create fluid mechanical conditions which improve the thermodynamic energy efficiency of the turbine system.

As noted above, the fuel for the oxy-fuel turbine generator may be natural gas, which is primarily methane, sometimes including varying amounts of other higher alkanes, and possibly a small percentage of carbon dioxide, nitrogen, hydrogen sulphide or helium. The fuel may be provided by a natural gas production system connected to new or pre-existing wells and producing reservoirs.

In embodiments where the fuel is natural gas or another hydrocarbon, the oxy-fuel turbine generator is preferably installed at or close to one or more natural gas producing reservoirs, for reasons that will be explained hereinbelow.

Hydrocarbon fuel for the oxy-fuel gas turbine generator may be received into the system from a subsurface reservoir at a production well head. The fuel may be received at any pressure above 100 kPa (1 bar). The fuel may be in a temperature range from −20° C. to +60° C. The fuel may be condensed to liquid phase and pumped to a pressure of 2 MPa (20 bar) to 7 MPa (70 bar) nominal operating pressure. The nominal respective gas temperature resulting from adiabatic compression may be from 60° C. to 200° C. The compressed fuel may be vaporised and injected into the combustion chamber of the oxy-fuel gas turbine generator at any temperature above 0° C.

As noted above, a pumped liquid oxygen feed may comprise at least 90 vol %, at least 95 vol % or at least 98 vol % oxygen. Liquid oxygen may be produced by a cryogenic air separation module. The cryogenic air separation module may be configured to take ambient air at a pressure of around 100 kPa (1 bar). The cryogenic air separation module may be configured to take ambient air at temperatures between −40° C. and +60° C. The cryogenic air separation module produces oxygen through a fractionation process. By-products of the fractionation process, such as nitrogen, argon and other trace gases, may be used as a heat sink to pre-cool compressed ambient air prior to entering the fractionation process. The warmed heat sink gases may subsequently be released to atmosphere.

The oxygen feed is pumped to a pressure of 2 MPa (20 bar) to 7 MPa (70 bar) in the liquid phase. The liquid phase pumped oxygen may be heated to a temperature sufficient to vaporise into the gas phase prior to or at injection into the combustion chamber. Steam may be injected at the steam feed of the first stage oxy-fuel gas turbine generator at pressures between 2 MPa (20 bar) and 7 MPa (70 bar). Steam may be injected at the steam feed of the combustion chamber at temperatures between 220° C. and 500° C. The steam may help to moderate fluid temperatures and to increase the density of the working fluid. Fluid conditions are maintained below allowable temperature, pressure and flow rate conditions as determined by the mechanical properties of the first stage expander turbine section of the oxy-fuel gas turbine generator. In some embodiments, the maximum allowable inlet temperature of the first stage expander turbine section of the oxy-fuel gas turbine generator is 1350° C. In some embodiments, the maximum allowable inlet pressure of the first stage expander turbine section of the oxy-fuel gas turbine generator is 7 MPa (70 bar). However, the maximum temperature and/or pressure will depend on actual fluid density and flow rates.

The fluids entering the first stage expander turbine section of the oxy-fuel gas turbine generator may be in a temperature range from 800° C. to 1350° C. The fluids entering the first stage expander turbine section of the oxy-fuel gas turbine generator may be in a pressure range from 2 MPa (20 bar) to 7 MPa (70 bar). The fluids may undergo adiabatic expansion in the first stage expander turbine section of the oxy-fuel gas turbine generator. The exhaust from the first stage expander turbine section of the oxy-fuel gas turbine generator may comprise fluids in a pressure range from 600 kPa (6 bar) to 1 MPa (10 bar). The exhaust from the first stage expander turbine section of the oxy-fuel gas turbine generator may comprise fluids in a temperature range from 320° C. to 780° C. The expansion of fluids in the first stage expander turbine section produces work that can drive an electrical generator. In some embodiments, the generator may be an asynchronous generator. In some embodiments, the generator may be connected to an electricity supply grid.

The exhaust fluids from the first stage expander turbine section may be heated by the combustion reheater to temperatures in a range from 525° C. to 1350° C. The pressure of the exhaust fluids may be in a range from 600 kPa (6 bar) to 1 MPa (10 bar).

The reheated fluids may be fed into the additional expander turbine section to undergo adiabatic expansion. The exhaust from the additional expander turbine section may be in a temperature range from 320° C. to 650° C. The exhaust from the additional expander turbine section may be at a pressure of around 120 kPa (1.2 bar). The expansion of fluid in the additional expander turbine section produces work that can drive an electrical generator, which may be the same electrical generator as driven by the first stage expander turbine section, and/or may be an additional electrical generator. In some embodiments, the additional generator may be an asynchronous generator. In some embodiments, the additional generator may be connected to an electricity supply grid.

An integrated recuperator and separator may be provided to take the exhaust fluids from the expander turbine section, or (where provided) the additional expander turbine section, and to condense water and extract gas phase carbon dioxide from the exhaust fluids. The integrated recuperator and separator may comprise an integrated system including a heat exchanger, a heat recuperator, a condenser and a multiphase separator. The integrated recuperator and separator may be configured to perform two-phase separation on the exhaust fluids. At entry into the integrated recuperator and separator, heat may be recovered from the exhaust fluids by way of a heat exchanger to heat recirculated water to form steam at a temperature in a range of 225° C. to 400° C. The steam may be at a pressure from 2 MPa (20 bar) to 7 MPa (70 bar). The resultant pre-heated steam is then returned for recycling through the oxy-fuel gas turbine generator. The steam may be fed to the first stage combustion chamber of the oxy-fuel gas turbine generator.

Water at ambient temperature and pressure, for example seawater (in the case of offshore or coastal installations), may be used as a tertiary cooling source for the exhaust fluids from the oxy-fuel gas turbine generator in the integrated recuperator and separator. The water may be in a temperature range from 5° C. to 30° C. The exhaust fluids may be cooled to a temperature of 30° C. to 95° C. prior to carbon dioxide separation. The cooled exhaust fluids may be passed through a two-phase separator to separate carbon dioxide and water components. A proportion of the produced water is recirculated to the oxy-fuel gas turbine generator, and any remainder may be degassed of residual carbon dioxide and disposed of.

The produced carbon dioxide, for example at a concentration from 92 vol % to 96 vol %, may be compressed by one or more compressors and cooled with water, for example seawater, to dehydrate the carbon dioxide and to condense to the liquid phase. The one or more compressors may be electrically driven using power generated by the oxy-fuel gas turbine generator. Any residual water produced during compression may be separated at each compression stage.

The liquid phase carbon dioxide may be discharged into the same underground reservoir from which the fuel for the turbine system has been extracted. The carbon dioxide may be discharged into the reservoir through one or more injection wells. The carbon dioxide remains in a dense phase, and depending on the depth of the reservoir, may be in a supercritical phase. This may have the effect of increasing reservoir pressure over time. This may assist fuel, for example natural gas, production through the process of re-pressurisation of the reservoir.

The oxy-fuel gas turbine generator may thus be or form part of a mostly closed circuit system in which carbon dioxide generated from combustion is sequestered back into the reservoir from which the fuel for the oxy-fuel gas turbine generator is extracted. This helps to reduce the greenhouse gas emissions resulting from combustion of natural gas and electricity generation by the oxy-fuel gas turbine generator. In addition, by using an oxy-fuel combustion process, generation of NOₓ gases is also significantly reduced.

Viewed from a second aspect, there is provided an integrated recuperator and separator comprising:
an evaporator heat exchanger having an exhaust fluid inlet and an exhaust fluid outlet, and a water inlet and a steam outlet;
an economiser heat exchanger having an exhaust fluid inlet connected to the exhaust fluid outlet of the evaporator heat exchanger and an exhaust fluid outlet, and a water inlet and a water outlet, the water outlet being connected to the water inlet of the evaporator heat exchanger;
a first stage condenser having an exhaust fluid inlet connected to the exhaust fluid outlet of the economiser heat exchanger and an exhaust fluid outlet, and a cooling water inlet and a cooling water outlet; and
a second stage condenser and separator having an exhaust fluid inlet connected to the exhaust fluid outlet of the first stage condenser, a separated carbon dioxide outlet, a separated water outlet connected to the water inlet of the economiser heat exchanger, a cooling water inlet and a cooling water outlet, the cooling water outlet connected to the cooling water inlet of the first stage condenser.

A pump may be provided between the separated water outlet of the second stage condenser and separator and the water inlet of the economiser heat exchanger.

A pump may be provided between the water outlet of the economiser heat exchanger and the water inlet of the evaporator heat exchanger.

A surplus produced water drainage outlet may be provided between the water outlet of the economiser heat exchanger and the water inlet of the evaporator heat exchanger.

The second stage condenser and separator may be configured as a substantially vertical column with a main body and a top portion. The separated carbon dioxide outlet may be at a top end of the top portion of the column, and the separated water outlet may be at a bottom end of main body of the column. The exhaust fluid inlet of the second stage condenser and separator may be disposed on a side wall of the main body of the column. The top portion of the column may have a shell and tube configuration, with the cooling water inlet and cooling water outlet being shell-side, and the separated carbon dioxide outlet being tube-side. The input to the tube-side of the top portion of the column receives gaseous phase carbon dioxide, separated from the exhaust fluid, from the main body of the column. The cooling water inlet and cooling water outlet may both be disposed on the top portion of the column. The cooling water inlet may be closer to the separated carbon dioxide outlet, and the cooling water outlet may be closer to the separated carbon dioxide inlet. The main body of the second stage condenser and separator may be configured as a largely empty vessel, optionally provided with internal horizontal and/or angled baffles to increase a dwell time of the separated water as it passed through the main body. This may encourage additional release of dissolved carbon dioxide.

The evaporator heat exchanger may have a shell and tube configuration. The exhaust fluid inlet and exhaust fluid outlet may be shell-side. The water inlet and steam outlet may be tube-side. It is generally preferred for higher pressure fluids to be tube-side in a shell and tube heat exchanger.

The economiser heat exchanger may have a shell and tube configuration. The exhaust fluid inlet and exhaust fluid outlet may be tube-side. The water inlet and water outlet may be shell-side. This configuration is most appropriate for the pressures and heat transfer coefficients pertaining in the economiser heat exchanger, as well as the preferred geometry of the connection between the economiser heat exchanger and the first stage condenser.

The first stage condenser may have a shell and tube configuration. The cooling water inlet and cooling water outlet may be shell-side. The exhaust fluid inlet and outlet may be tube-side. The cooling water outlet of the first stage condenser may be connected to a cooling water disposal system.

The integrated recuperator and separator may be configured as a single unit with the evaporator heat exchanger connected to the economiser heat exchanger, the economiser heat exchanger connected to the first stage condenser, and the first stage condenser connected to the second stage condenser and separator. The evaporator heat exchanger, economiser heat exchanger and first stage condenser may be arranged end-to-end in a substantially horizontal, linear arrangement, and the second stage condenser and separator may be arranged vertically at one end of the first stage condenser.

The integrated recuperator and separator of the second aspect is particularly well-suited to receive exhaust fluids from oxy-fuel gas turbine generator of the first aspect, to generate steam for injection into the combustion chamber oxy-fuel gas turbine generator of the first aspect, and to separate carbon dioxide from the exhaust fluids from the oxy-fuel gas turbine generator of the first aspect.

The integrated recuperator and separator of the second aspect may be connected with the exhaust fluid inlet of the evaporator heat exchanger connected to an exhaust of the oxy-fuel gas turbine generator of the first aspect, for example an exhaust of the second stage additional expander turbine section, and with the steam outlet of the evaporator heat exchanger connected to the steam feed of the first stage combustion chamber of the oxy-fuel gas turbine generator of the first aspect.

The separated carbon dioxide output by the second stage condenser and separator may be compressed and cooled to the liquid phase before being pumped into the subsurface reservoir as discussed hereinabove.

When the integrated recuperator and separator of the second aspect is connected to the oxy-fuel gas turbine generator of embodiments of the first aspect, exhaust fluids from the second stage expander turbine section are passed into the exhaust fluid inlet of the evaporator heat exchanger. The exhaust fluid may be input at a temperature from 320° C. to 650° C. The exhaust fluid may be input at a pressure of around 120 kPa (1.2 bar).

Preheated, high pressure water is passed to the water inlet of the evaporation heat exchanger and may be output as high pressure, saturated steam from the steam outlet. The water at the water inlet may be at a temperature from 65° C. to 95° C. The water at the water inlet may be at a pressure from 2 MPa (20 bar) to 7 MPa (70 bar). The steam at the steam outlet may be at a temperature from 225° C. to 450° C. The steam at the steam outlet may be at a pressure from 2 MPa (20 bar) to 7 MPa (70 bar). If the evaporator heat exchanger is a shell and tube evaporator heat exchanger, it is preferable for the water inlet and steam outlet to be tube-side, since the water/steam is at higher pressure than the exhaust fluid, which is preferably shell-side.

Exhaust fluid may exit the exhaust fluid outlet of the evaporator heat exchanger and enter the exhaust fluid inlet of the economiser heat exchanger at a temperature from 150° C. to 275° C. Exhaust fluid may exit the exhaust fluid outlet of the evaporator heat exchanger and enter the exhaust fluid inlet of the economiser heat exchanger at a pressure of around 110 kPa (1.1 bar). Water may enter the water inlet of the economiser heat exchanger at a temperature from 25° C. to 65° C. Water may enter the water inlet of the economiser heat exchanger at a pressure of around 200 kPa (2 bar). Water may exit the water outlet of the economiser heat exchanger at a temperature from 62° C. to 93° C. Water may exit the water outlet of the economiser heat exchanger at a pressure of around 200 kPa (2 bar). In certain embodiments, the exhaust fluid inlet and exhaust fluid outlet of the economiser heat exchanger are tube-side, and the water inlet and water outlet are shell-side. The water exiting the water outlet of the economiser heat exchanger may have its flow managed by control valves to split the output between a pump that feeds water at high pressure to the water inlet of the evaporator heat exchanger and a surplus water drainage outlet.

Exhaust fluid may exit the exhaust fluid outlet of the economiser heat exchanger and enter the exhaust fluid inlet of the first stage condenser at a temperature from 55° C. to 65° C. Exhaust fluid may exit the exhaust fluid outlet of the economiser heat exchanger and enter the exhaust fluid inlet of the first stage condenser at a pressure of around 100 kPa (1 bar). Cooling water may enter the cooling water inlet of the first stage condenser at a temperature from 15° C. to 45° C. Cooling water may exit the cooling water outlet of the first stage condenser at a temperature from 45° C. to 65° C. The cooling water exiting the cooling water outlet of the first stage condenser may be disposed of by way of a managed cooling water disposal system. Exhaust fluid may exit the exhaust fluid outlet of the first stage condenser at a temperature from 25° C. to 65° C. Exhaust fluid may exit the exhaust fluid outlet of the first stage condenser at a pressure of around 80 kPa (0.8 bar) to 90 kPa (0.9 bar). In certain embodiments, the exhaust fluid inlet and exhaust fluid outlet of the first stage condenser are tube-side and the cooling water inlet and cooling water outlet of the first stage condenser are shell-side.

Exhaust fluid may exit the exhaust fluid outlet of the first stage condenser and enter the exhaust fluid inlet of the second stage condenser and separator at a temperature from 25° C. to 65° C. Exhaust fluid may exit the exhaust fluid outlet of the first stage condenser and enter the exhaust fluid inlet of the second stage condenser and separator at a pressure of around 80 kPa (0.8 bar) to 90 kPa (0.9 bar). The exhaust fluid entering the exhaust fluid inlet of the second stage condenser and separator may comprise or consist of liquid water, water vapour, carbon dioxide and trace elements.

Cooling water may enter the cooling water inlet of the second stage condenser and separator at a temperature from 5° C. to 25° C. Cooling water may exit the cooling water outlet of the second stage condenser and separator at a temperature from 15° C. to 45° C. and be passed to the cooling water inlet of the first stage condenser. The cooling water inlet and outlet of the second stage condenser and separator may be in a top portion of the second stage condenser and separator configured as a shell and tube heat exchanger. The cooling water inlet and outlet may be shell-side.

Gaseous components (primarily carbon dioxide and water vapour) of the exhaust fluid in the second stage condenser and separator may pass through the top portion of the second stage condenser and separator tube-side. Water vapour may condense from the exhaust fluid in the top portion of the second stage condenser and separator and fall down as water into the main body of the second stage condenser and separator. The top portion of the second stage condenser and separator includes a separated carbon dioxide outlet through which separated carbon dioxide is output. The separated carbon dioxide may be output at a temperature of 25° C. to 45° C. The separated carbon dioxide may be output at a pressure of 80 kPa (0.8 bar) to 90 kPa (0.9 bar).

Separated water from the second stage condenser and separator may exit the separated water outlet at a temperature from 25° C. to 65° C. Separated water from the second stage condenser and separator may exit the separated water outlet at a pressure of around 80 kPa (0.8 bar) to 90 kPa (0.9 bar). The separated water exiting the second stage condenser and separator may be fed to a pump. The pump may pressurise the separated water to a pressure of around 200 kPa (2 bar). The pressurised separated water is then fed to the water inlet of the economiser heat exchanger.

The pump between the separated water outlet of the second stage condenser and separator and the water inlet of the economiser heat exchanger may be powered by electricity generated by the oxy-fuel gas turbine generator of the first aspect. The pump between the water outlet of the economiser heat exchanger and the water inlet of the evaporator heat exchanger may be powered by electricity generated by the oxy-fuel gas turbine generator of the first aspect.

Embodiments of the second aspect may provide one or more advantages, in particular but not exclusively in combination with embodiments of the first aspect. Increasing the mass density of the working fluid in the oxy-fuel gas turbine generator of the first aspect can improve thermodynamic efficiency. Selection of the components of the working fluid stream requires consideration of the compressibility of the components and any consequent latent energy effects through the process cycle for the working fluid. Using water, in both liquid and steam phases, as a component of the working fluid helps to increase the mass density of the working fluid. Latent energy losses arising from condensation and evaporation through the cycle may be managed by way of a system of partially closed circuit evaporators, condensers and two phase separators, for example by way of the integrated recuperator and separator of the second aspect.

To increase thermodynamic efficiency, it is preferable that water is not condensed from the exhaust fluid in the integrated recuperator and separator at too low a temperature so as to ensure that sufficient energy remains available from the recovery process for re-evaporating the condensed water into steam for recycling. However, condensation at too high a temperature results in less efficient separation of water from carbon dioxide. As a result, the separated carbon dioxide will contain more water vapour, and would require additional water separation processing subsequent to compression of the produced carbon dioxide into the dense liquid or supercritical phase. The exemplary operating temperatures and pressures set out hereinabove may facilitate efficient operation of the integrated recuperator and separator in this regard.

Viewed from a third aspect, there is provided a turbine system comprising an oxy-fuel gas turbine generator comprising a combustion chamber section and an expander turbine section, a pumped liquid oxygen feed connected to the combustion chamber, a pumped liquid fuel feed connected to the combustion chamber, and a steam feed connected to the combustion chamber, wherein liquid oxygen and liquid fuel are vaporized injected into and combusted in the combustion chamber in the presence of steam, and exhaust fluids from the combustion chamber are expanded through the expander turbine section to drive an electrical generator, wherein water and/or steam from the exhaust fluids from the expander turbine section is separated and recirculated as steam to the steam feed of the combustion chamber by way of an integrated recuperator and separator comprising: an evaporator heat exchanger having an exhaust fluid inlet connected to an exhaust fluid outlet of the oxy-fuel gas turbine generator and an exhaust fluid outlet, and a water inlet and a steam outlet connected to the steam feed of the combustion chamber; an economiser heat exchanger having an exhaust fluid inlet connected to the exhaust fluid outlet of the evaporator heat exchanger and an exhaust fluid outlet, and a water inlet and a water outlet, the water outlet being connected to the water inlet of the evaporator heat exchanger; a first stage condenser having an exhaust fluid inlet connected to the exhaust fluid outlet of the economiser heat exchanger and an exhaust fluid outlet, and a cooling water inlet and a cooling water outlet; and a second stage condenser and separator having an exhaust fluid inlet connected to the exhaust fluid outlet of the first stage condenser, a separated carbon dioxide outlet, a separated water outlet connected to the water inlet of the economiser heat exchanger, a cooling water inlet and a cooling water outlet, the cooling water outlet connected to the cooling water inlet of the first stage condenser.

Fuel for the turbine system may be drawn from a subsurface reservoir, for example a subsurface natural gas reservoir. The separated carbon dioxide output by the second stage condenser and separator may be condensed and sequestered in the subsurface reservoir as discussed hereinabove.

Viewed from a fourth aspect, there is provided a method of electrical power generation, wherein:
i) liquid oxygen and liquid fuel are pumped to a predetermined pressure, vaporised and combusted in a combustion chamber of an oxy-fuel gas turbine generator in the presence of steam;
ii) exhaust fluids from the combustion chamber are expanded through an expander turbine section of the oxy-fuel gas turbine generator so as to drive an electrical generator; and
iii) water from exhaust fluids from the oxy-fuel gas turbine generator is separated and recirculated as steam to the combustion chamber.

Viewed from a fifth aspect, there is provided a method of electrical power generation, wherein:
i) liquid oxygen and liquid fuel are pumped to a predetermined pressure, vaporised and combusted in a combustion chamber of an oxy-fuel gas turbine generator in the presence of steam;
ii) exhaust fluids from the combustion chamber are expanded through an expander turbine section of the oxy-fuel gas turbine generator so as to drive an electrical generator;
iii) exhaust fluids from the oxy-fuel gas turbine generator are passed through an evaporator heat exchanger having an exhaust fluid inlet and an exhaust fluid outlet, and a water inlet and a steam outlet;
iv) the exhaust fluids are then passed through an economiser heat exchanger having an exhaust fluid inlet connected to the exhaust fluid outlet of the evaporator heat exchanger and an exhaust fluid outlet, and a water inlet and a water outlet, the water outlet being connected to the water inlet of the evaporator heat exchanger;
v) the exhaust fluids are then passed through a first stage condenser having an exhaust fluid inlet connected to the exhaust fluid outlet of the economiser heat exchanger and an exhaust fluid outlet, and a cooling water inlet and a cooling water outlet;
vi) the exhaust fluids are then passed through a second stage condenser and separator having an exhaust fluid inlet connected to the exhaust fluid outlet of the first stage condenser, a separated carbon dioxide outlet, a separated water outlet connected to the water inlet of the economiser heat exchanger, a cooling water inlet and a cooling water outlet, the cooling water outlet connected to the cooling water inlet of the first stage condenser;
viii) separated carbon dioxide is extracted by way of the separated carbon dioxide outlet; and
ix) steam from the steam outlet of the evaporator heat exchanger in step iv) is recirculated and provided to the combustion chamber of the oxy-fuel gas turbine generator as the steam in step i).

The exhaust fluids from the expander turbine section may be reheated in a combustion reheater and subsequently further expanded through an additional expander turbine section so as to drive the electrical generator and/or a further electrical generator.

The pumped liquid oxygen feed may be supplied by a cryogenic air separator.

The fuel may be a hydrocarbon.

The fuel may be natural gas, and may be extracted from a subsurface natural gas reservoir. Carbon dioxide separated from the exhaust fluids of the oxy-fuel gas turbine generator may be condensed and returned to the subsurface natural gas reservoir. The separated carbon dioxide may be compressed to a liquid or supercritical phase before being returned to the subsurface natural gas reservoir by pumping.

Alternatively, the fuel may be hydrogen.

Viewed from a sixth aspect, there is provided a method of separating carbon dioxide from water in turbine exhaust fluids, wherein:
i) the turbine exhaust fluids are passed through an evaporator heat exchanger having an exhaust fluid inlet and an exhaust fluid outlet, and a water inlet and a steam outlet;
ii) the turbine exhaust fluids are then passed through an economiser heat exchanger having an exhaust fluid inlet connected to the exhaust fluid outlet of the evaporator heat exchanger and an exhaust fluid outlet, and a water inlet and a water outlet, the water outlet being connected to the water inlet of the evaporator heat exchanger;
iii) the turbine exhaust fluids are then passed through a first stage condenser having an exhaust fluid inlet connected to the exhaust fluid outlet of the economiser heat exchanger and an exhaust fluid outlet, and a cooling water inlet and a cooling water outlet;
iv) the turbine exhaust fluids are then passed through a second stage condenser and separator having an exhaust fluid inlet connected to the exhaust fluid outlet of the first stage condenser, a separated carbon dioxide outlet, a separated water outlet connected to the water inlet of the economiser heat exchanger, a cooling water inlet and a cooling water outlet, the cooling water outlet connected to the cooling water inlet of the first stage condenser; and
v) separated carbon dioxide is extracted by way of the separated carbon dioxide outlet.

Viewed from a seventh aspect, there is provided a method of power generation, wherein:
a) natural gas is extracted from a subsurface reservoir;
b) oxygen is separated from ambient air;
c) the natural gas and the oxygen are com busted together with steam, and combustion gases comprising carbon dioxide and steam are expanded through a turbine generator to generate electrical power;
d) exhaust fluids from the turbine generator are passed through a heat recuperator and steam condenser;
e) carbon dioxide is separated from the exhaust fluids from the heat recuperator and steam condenser to provide a flow of carbon dioxide;
f) water is separated from the exhaust fluids from the heat recuperator and steam condenser to provide a flow of water;
g) the flow of water is passed back through the heat recuperator and steam condenser to provide a flow of steam;
h) the flow of steam is recycled to step c);
i) the flow of carbon dioxide is compressed to a liquid or supercritical phase;
j) the liquid or supercritical carbon dioxide is injected into the subsurface reservoir to sequester the carbon dioxide and to re-pressurise the subsurface reservoir.

Viewed from an eighth aspect, there is provided a system for power generation, the system comprising:
a) a natural gas production manifold connected to a subsurface natural gas reservoir;
b) an oxygen separation module configured to separate oxygen from ambient air;
c) an oxy-fuel combustor to combust natural gas from the natural gas production manifold with oxygen from the oxygen separation module in the presence of steam so as to produce combustion gases comprising carbon dioxide and steam;
d) a turbine generator configured to expand the combustion gases and to generate electrical power;
e) a heat recuperator and steam condenser configured to receive exhaust fluids from the turbine generator;
d) a carbon dioxide and water separator configured to separate carbon dioxide and water from the exhaust fluids after they have passed through the heat recuperator and steam condenser;
e) a first return flowline to return the separated water through the heat recuperator and steam condenser to generate steam, and a second return flowline to recycle the generated steam to the oxy-fuel combustor in c);
f) a carbon dioxide compressor to receive the carbon dioxide from the carbon dioxide and water separator and to compress the carbon dioxide to a liquid or supercritical phase; and
g) a carbon dioxide injection manifold connected to the subsurface natural gas reservoir, and configured to sequester the carbon dioxide and to re-pressurise the subsurface reservoir.

Embodiments of the present disclosure are particularly useful when installed at or close to natural gas producing reservoirs, for reasons that will be explained hereinbelow.

The system may be configured for onshore or offshore installation. Preferably, the system is configured for offshore installation, in which case the natural gas production manifold, the oxygen separation module, the oxy-fuel combustor, the turbine generator, the heat recuperator and steam condenser, the carbon dioxide and water separator, the first and second flowlines, the carbon dioxide compressor and the carbon dioxide injection manifold may be disposed together on a single offshore platform or rig, or on two or more adjacent offshore platforms or rigs. The natural gas production manifold and the carbon dioxide injection manifold may be connected to respective wellheads, which in turn are connected to the subsurface natural gas reservoir. Advantageously, the natural gas production manifold wellhead is connected to a first part of the subsurface natural gas reservoir and the carbon dioxide injection manifold is connected to a second, different part of the subsurface natural gas reservoir. Preferably, the first and second parts of the subsurface natural gas reservoir are sufficiently spaced from each other that carbon dioxide injected at the second part does not significantly dilute the natural gas extracted at the first part.

The oxygen separation module may be a cryogenic oxygen separation module. The cryogenic oxygen separation module may be powered with electricity generated by the turbine generator. The cryogenic oxygen separation module may be configured to use fresh or seawater as a coolant. The cryogenic air separation module may be configured to take ambient air at a pressure of around 100 kPa (1 bar). The cryogenic air separation module may be configured to take ambient air at temperatures between −40° C. and +60° C. The cryogenic air separation module may be configured to produce oxygen through a fractionation process. By-products of the fractionation process, such as nitrogen, argon and other trace gases, may be used as a heat sink to pre-cool compressed ambient air prior to entering the fractionation process. The warmed heat sink gases may subsequently be released to atmosphere.

The oxy-fuel combustor is configured to use oxygen (rather than air) as an oxidant, and natural gas as a fuel. The oxygen may be provided from the oxygen separation module as 90 vol %, at least 95 vol % or at least 98 vol % oxygen. Advantageously, the oxygen pressurised to a predetermined pressure, for example from 2 MPa (20 bar) to 7M Pa (70 bar) while in the liquid phase, for example by way of pumping. This is considerably more efficient than pressurising gaseous oxygen by compression. The pressurised liquid oxygen may then be vaporised and injected into the oxy-fuel combustor at the elevated pressure. An oxy-fuel combustor has a number of advantages over an air-fuel combustor. A primary advantage is that oxy-fuel combustion yields a combustion gas that is rich in carbon dioxide, suitable for separation and sequestration. The combustion gas will contain little or no NOₓ or other pollutants, and is primarily carbon dioxide and water. As such, separation of carbon dioxide from the exhaust fluid mix is facilitated.

In some embodiments, the oxygen is presented by the oxygen separation module to the oxy-fuel combustor in the gas phase at a temperature above its liquification temperature (−183° C.) and below the ambient temperature and at a pressure between 2 MPa (20 bar) and 7 MPa (70 bar). The oxygen is pumped up to the required pressure while in the liquid phase, and may be used to cool ambient air that is supplied to the oxygen separation module for separation. The heat extracted from the incoming air may be used to vaporise the pressurised oxygen prior to injection into the oxy-fuel combustor.

Oxy-fuel combustion typically takes place at a substantially higher temperature than air-fuel combustion, and this can be problematic when seeking to drive a turbine by way of expansion of the combustion gas. Accordingly, the method and system of the present disclosure add steam to the oxy-fuel combustor when combusting oxygen and natural gas. The steam can help to moderate the combustion temperature. The addition of steam may increase the heat capacity of the working fluid and help to moderate temperature fluctuations. The addition of steam may increase the density of the working fluid, and thus improve the thermodynamic energy efficiency of the system.

The fuel for the oxy-fuel combustor is natural gas, which is primarily methane, sometimes including varying amounts of other higher alkanes, and possibly a small percentage of carbon dioxide, nitrogen, hydrogen sulphide or helium. The fuel may be provided by a natural gas production system connected to new or pre-existing wells and producing reservoirs.

The natural gas fuel for the oxy-fuel combustor may be received from the natural gas production manifold at any pressure above 100 kPa (1 bar). The fuel may be in a temperature range from −20° C. to +60° C. The fuel may be compressed to between 2 MPa (20 bar) and 7 MPa (70 bar) nominal operating pressure and consequential respective gas temperatures resulting from adiabatic compression. The fuel may be pumped to the required pressure while in the liquid phase. The respective gas temperatures may, in some examples, be from 100° C. to 300° C. depending on the pressure ratio for compression. The compressed fuel may be vaporised and injected into the oxy-fuel combustor at any temperature above 0° C. The compressed fuel may also be fed to the oxy-fuel combustor in the liquid phase and vaporised in the combustor. This allows the fuel to be efficiently pressurised to a high pressure, for example from 2 MPa (20 bar) to 7 MPa (70 bar).

The combustion gases from the oxy-fuel combustor may be in a temperature range from 845° C. to 1350° C. The combustion gases from the oxy-fuel combustor may be in a pressure range from 2 MPa (20 bar) to 7 MPa (70 bar).

The high temperature, high pressure combustion gases from the oxy-fuel combustor are then expanded through one or more turbine generators. Expansion of the combustion gases causes turbine rotors of the one or more turbine generators to turn, and the rotational motion is used to generate electrical power in the usual manner. In some embodiments, the turbine generator may be an asynchronous generator. In some embodiments, the turbine generator may be connected to an electricity supply grid.

The addition of high pressure steam to the oxy-fuel combustor helps to increase the density of the turbine generator working fluid. A working fluid, in this context, is a fluid that primarily converts thermal energy into mechanical or kinetic energy expansion through one or more turbine rotors. In a conventional gas turbine generator, using air as an oxidant, there will be a high proportion of nitrogen in the air (typically around 78 vol %) to act as a useful component of the working fluid. However, a large amount of energy is needed to heat the nitrogen component of the working fluid, and much of this heat will be lost in the exhaust fluid if this is simply vented to atmosphere. The turbine generator of the present disclosure does not use nitrogen as a significant component of the working fluid, but instead uses steam. The steam is recycled to the oxy-fuel combustor, thus helping to reduce heat loss and to improve efficiency.

Additionally, the presence of steam can help to reduce or manage the combustion temperature, which can be useful when oxy-fuel combustion takes place at temperatures substantially higher than conventional air-fuel combustion. This can help to keep the temperature of the exhaust fluids within a range that can be tolerated by the turbine generator.

Pumping fuel and oxygen in the liquid phase is an efficient way of obtaining high pressures, for example 2 MPa (20 bar) to 7 MPa (70 bar), and means that there is no need for a compressor stage prior to the oxy-fuel combustor is conventional in a gas turbine generator. Conventional compressor stages are driven by the turbine rotors, and thus less energy is available for conversion into electrical power.

The heat recuperator and steam condenser may be configured to receive exhaust fluids from the turbine generator at a temperature of 320° C. to 650° C. The heat recuperator and steam condenser may be configured to receive exhaust fluids from the turbine generator at a pressure of around 120 kPa (1.2 bar).

Heat may be recovered from the exhaust fluids by way of the heat recuperator and steam condenser to heat recirculated water to form steam at a temperature in a range of 225° C. to 400° C. The steam may be at a pressure from 2 MPa (20 bar) to 7 MPa (70 bar). The resultant pre-heated steam is then recycled to the oxy-fuel combustor.

Water at ambient temperature and pressure, for example seawater (in the case of offshore or coastal installations), may be used as a tertiary cooling source for the exhaust fluids from the turbine generator in the heat recuperator and steam condenser. The water may be in a temperature range from 5° C. to 30° C. The exhaust fluids may be cooled to a temperature of 30° C. to 95° C. prior to supply to the carbon dioxide and water separator.

The carbon dioxide and water separator may be a two-phase separator to separate carbon dioxide and water components. A proportion of the produced water will be recirculated as steam to the oxy-fuel combustor as described hereinabove. Surplus produced water may be degassed of residual carbon dioxide and disposed of. Water, for example seawater (in the case of offshore or coastal installations), may be used as a cooling source in the carbon dioxide and water separator. The water may be in a temperature range from 5° C. to 30° C.

In some embodiments, the heat recuperator and steam condenser may be combined with the carbon dioxide and water separator in an integrated recuperator and separator module. The integrated recuperator and separator module may comprise an integrated system including a heat exchanger, a heat recuperator, a condenser and a multiphase separator. The integrated recuperator and separator may be configured to perform two-phase separation on the exhaust fluids. At entry into the integrated recuperator and separator, heat may be recovered from the exhaust fluids by way of a heat exchanger to heat recirculated water to form steam at a temperature in a range of 225° C. to 400° C. The steam may be at a pressure from 2 MPa (20 bar) to 7 MPa (70 bar). The resultant pre-heated wet steam is then fed to the oxy-fuel combustor.

The produced carbon dioxide, for example at a concentration from 92 vol % to 96 vol %, is fed to the carbon dioxide compressor to be compressed by one or more compressors and cooled with water, for example seawater, to dehydrate the carbon dioxide and to condense the carbon dioxide to the liquid or supercritical phase. The one or more compressors may be electrically driven using power generated by the turbine generator. Any residual water produced during compression may be separated at each compression stage.

The liquid or supercritical phase carbon dioxide is passed to the carbon dioxide injection manifold and then injected into the same subsurface reservoir from which the natural gas fuel for the system has been extracted. The carbon dioxide may be discharged into the reservoir through one or more injection wells. The carbon dioxide remains in a dense phase, preferably a liquid or supercritical phase, in the reservoir and has the effect of increasing reservoir pressure over time. This may assist natural gas production through re-pressurisation of the subsurface reservoir.

Embodiments of the present disclosure thus provide an at least partially closed circuit system in which carbon dioxide generated from combustion is sequestered back into the reservoir from which the fuel for the turbine system is extracted. This helps to reduce greenhouse gas emissions. Moreover, by using an oxy-fuel combustion process, generation of NOₓ gases is virtually eliminated. Recirculation of steam in the system helps to moderate the high temperatures inherent in oxy-fuel combustion processes.

The integrated recuperator and separator, where provided, may comprise:
an evaporator heat exchanger having an exhaust fluid inlet and an exhaust fluid outlet, and a water inlet and a steam outlet;
an economiser heat exchanger having an exhaust fluid inlet connected to the exhaust fluid outlet of the evaporator heat exchanger and an exhaust fluid outlet, and a water inlet and a water outlet, the water outlet being connected to the water inlet of the evaporator heat exchanger;
a first stage condenser having an exhaust fluid inlet connected to the exhaust fluid outlet of the economiser heat exchanger and an exhaust fluid outlet, and a cooling water inlet and a cooling water outlet; and a second stage condenser and separator having an exhaust fluid inlet connected to the exhaust fluid outlet of the first stage condenser, a separated carbon dioxide outlet, a separated water outlet connected to the water inlet of the economiser heat exchanger, a cooling water inlet and a cooling water outlet, the cooling water outlet connected to the cooling water inlet of the first stage condenser.

A pump may be provided between the separated water outlet of the second stage condenser and separator and the water inlet of the economiser heat exchanger.

A pump may be provided between the water outlet of the economiser heat exchanger and the water inlet of the evaporator heat exchanger.

A surplus produced water drainage outlet may be provided between the water outlet of the economiser heat exchanger and the water inlet of the evaporator heat exchanger.

The second stage condenser and separator may be configured as a substantially vertical column with a main body and a top portion. The separated carbon dioxide outlet may be at a top end of the top portion of the column, and the separated water outlet may be at a bottom end of main body of the column. The exhaust fluid inlet of the second stage condenser and separator may be disposed on a side wall of the main body of the column. The top portion of the column may have a shell and tube configuration, with the cooling water inlet and cooling water outlet being shell-side, and the separated carbon dioxide outlet being tube-side. The input to the tube-side of the top portion of the column receives gaseous phase carbon dioxide, separated from the exhaust fluid, from the main body of the column. The cooling water inlet and cooling water outlet may both be disposed on the top portion of the column. The cooling water inlet may be closer to the separated carbon dioxide outlet, and the cooling water outlet may be closer to the separated carbon dioxide inlet. The main body of the second stage condenser and separator may be configured as a largely empty vessel, optionally provided with internal horizontal and/or angled baffles or trays to increase a dwell time of the separated water as it passed through the main body. This may encourage additional release of dissolved carbon dioxide.

The evaporator heat exchanger may have a shell and tube configuration. The exhaust fluid inlet and exhaust fluid outlet may be shell-side. The water inlet and steam outlet may be tube-side. It is generally preferred for higher pressure fluids to be tube-side in a shell and tube heat exchanger.

The economiser heat exchanger may have a shell and tube configuration. The exhaust fluid inlet and exhaust fluid outlet may be tube-side. The water inlet and water outlet may be shell-side. This configuration is most appropriate for the pressures and heat transfer coefficients pertaining in the economiser heat exchanger, as well as the preferred geometry of the connection between the economiser heat exchanger and the first stage condenser. The first stage condenser may have a shell and tube configuration. The cooling water inlet and cooling water outlet may be shell-side. The exhaust fluid inlet and outlet may be tube-side. The cooling water outlet of the first stage condenser may be connected to a cooling water disposal system.

The integrated recuperator and separator may be configured as a single unit with the evaporator heat exchanger connected to the economiser heat exchanger, the economiser heat exchanger connected to the first stage condenser, and the first stage condenser connected to the second stage condenser and separator. The evaporator heat exchanger, economiser heat exchanger and first stage condenser may be arranged end-to-end in a substantially horizontal, linear arrangement, and the second stage condenser and separator may be arranged vertically at one end of the first stage condenser.

The integrated recuperator and separator of the second aspect is particularly well-suited to receive exhaust fluid from the turbine generator of the turbine system, to generate steam for injection into the oxy-fuel combustor, and to separate carbon dioxide from the exhaust fluid from the turbine generator.

The integrated recuperator and separator may be connected with the exhaust fluid inlet of the evaporator heat exchanger connected to an exhaust of turbine generator, and with the steam outlet of the evaporator heat exchanger connected to the oxy-fuel combustor.

The separated carbon dioxide output by the second stage condenser and separator may be compressed and cooled to the liquid phase before being pumped into the subsurface reservoir as discussed hereinabove.

When the integrated recuperator and separator is connected to the turbine generator, exhaust fluids from the turbine generator are passed into the exhaust fluid inlet of the evaporator heat exchanger. The exhaust fluid may be input at a temperature from 320° C. to 650° C. The exhaust fluid may be input at a pressure of around 120 kPa (1.2 bar).

Preheated, high pressure water is passed to the water inlet of the evaporation heat exchanger and may be output as high pressure, saturated steam from the steam outlet. The water at the water inlet may be at a temperature from 65° C. to 95° C. The water at the water inlet may be at a pressure from 2 MPa (20 bar) to 7 MPa (70 bar). The steam at the steam outlet may be at a temperature from 225° C. to 450° C. The steam at the steam outlet may be at a pressure from 2 MPa (20 bar) to 7 MPa (70 bar). If the evaporator heat exchanger is a shell and tube evaporator heat exchanger, it is preferable for the water inlet and steam outlet to be tube-side, since the water/steam is at higher pressure than the exhaust fluid, which is preferably shell-side.

Exhaust fluid may exit the exhaust fluid outlet of the evaporator heat exchanger and enter the exhaust fluid inlet of the economiser heat exchanger at a temperature from 150° C. to 275° C. Exhaust fluid may exit the exhaust fluid outlet of the evaporator heat exchanger and enter the exhaust fluid inlet of the economiser heat exchanger at a pressure of around 110 kPa (1.1 bar). Water may enter the water inlet of the economiser heat exchanger at a temperature from 25° C. to 65° C. Water may enter the water inlet of the economiser heat exchanger at a pressure of around 200 kPa (2 bar). Water may exit the water outlet of the economiser heat exchanger at a temperature from 62° C. to 93° C. Water may exit the water outlet of the economiser heat exchanger at a pressure of around 200 kPa (2 bar). In certain embodiments, the exhaust fluid inlet and exhaust fluid outlet of the economiser heat exchanger are tube-side, and the water inlet and water outlet are shell-side. The water exiting the water outlet of the economiser heat exchanger may have its flow managed by control valves to split the output between a pump that feeds water at high pressure to the water inlet of the evaporator heat exchanger and a surplus water drainage outlet.

Exhaust fluid may exit the exhaust fluid outlet of the economiser heat exchanger and enter the exhaust fluid inlet of the first stage condenser at a temperature from 55° C. to 65° C. Exhaust fluid may exit the exhaust fluid outlet of the economiser heat exchanger and enter the exhaust fluid inlet of the first stage condenser at a pressure of around 100 kPa (1 bar). Cooling water may enter the cooling water inlet of the first stage condenser at a temperature from 15° C. to 45° C. Cooling water may exit the cooling water outlet of the first stage condenser at a temperature from 45° C. to 65° C. The cooling water exiting the water outlet of the first stage condenser may be disposed of by way of a managed cooling water disposal system. Exhaust fluid may exit the exhaust fluid outlet of the first stage condenser at a temperature from 25° C. to 65° C. Exhaust fluid may exit the exhaust fluid outlet of the first stage condenser at a pressure of around 80 kPa (0.8 bar) to 90 kPa (0.9 bar). In certain embodiments, the exhaust fluid inlet and exhaust fluid outlet of the first stage condenser are tube-side and the cooling water inlet and cooling water outlet of the first stage condenser are shell-side.

Exhaust fluid may exit the exhaust fluid outlet of the first stage condenser and enter the exhaust fluid inlet of the second stage condenser and separator at a temperature from 25° C. to 65° C. Exhaust fluid may exit the exhaust fluid outlet of the first stage condenser and enter the exhaust fluid inlet of the second stage condenser and separator at a pressure of around 80 kPa (0.8 bar) to 90 kPa (0.9 bar). The exhaust fluid entering the exhaust fluid inlet of the second stage condenser and separator may comprise or consist of liquid water, water vapour, carbon dioxide and trace elements.

Cooling water may enter the cooling water inlet of the second stage condenser and separator at a temperature from 5° C. to 25° C. Cooling water may exit the cooling water outlet of the second stage condenser and separator at a temperature from 15° C. to 45° C. and be passed to the cooling water inlet of the first stage condenser. The cooling water inlet and outlet of the second stage condenser and separator may be in a top portion of the second stage condenser and separator configured as a shell and tube heat exchanger. The cooling water inlet and outlet may be shell-side.

Gaseous components (primarily carbon dioxide and water vapour) of the exhaust fluid in the second stage condenser and separator may pass through the top portion of the second stage condenser and separator tube-side. Water vapour may condense from the exhaust fluid in the top portion of the second stage condenser and separator and fall down as water into the main body of the second stage condenser and separator. The top portion of the second stage condenser and separator includes a separated carbon dioxide outlet through which separated carbon dioxide is output. The separated carbon dioxide may be output at a temperature of 25° C. to 45° C. The separated carbon dioxide may be output at a pressure of 80 kPa (0.8 bar) to 90 kPa (0.9 bar).

Separated water from the second stage condenser and separator may exit the separated water outlet at a temperature from 25° C. to 65° C. Separated water from the second stage condenser and separator may exit the separated water outlet at a pressure of around 80 kPa (0.8 bar) to 90 kPa (0.9 bar). The separated water exiting the second stage condenser and separator may be fed to a pump. The pump may pressurise the separated water to a pressure of around 200 kPa (2 bar). The pressurised separated water is then fed to the water inlet of the economiser heat exchanger.

The pump between the separated water outlet of the second stage condenser and separator and the water inlet of the economiser heat exchanger may be powered by electricity generated by the turbine generator. The pump between the water outlet of the economiser heat exchanger and the water inlet of the evaporator heat exchanger may be powered by electricity generated by the turbine generator.

Embodiments of the disclosure may provide one or more advantages. Increasing the mass density of the working fluid can improve thermodynamic efficiency. Selection of the components of the working fluid stream requires consideration of the compressibility of the components and any consequent latent energy effects through the process cycle for the working fluid. Using water, in both liquid and steam phases, as a component of the working fluid helps to increase the mass density of the working fluid. Latent energy losses arising from condensation and evaporation through the cycle may be managed by way of a system of partially closed circuit evaporators, condensers and two phase separators, for example by way of the integrated recuperator and separator.

To increase thermodynamic efficiency, it is preferable that water is not condensed from the exhaust fluid in the integrated recuperator and separator at too low a temperature, since this might reduce the energy budget available for re-evaporating the water into steam for recycling. However, condensation at too high a temperature results in less efficient separation of water from carbon dioxide. As a result, the separated carbon dioxide will contain more water vapour, and this may adversely impact subsequent compression of carbon dioxide into the dense liquid or supercritical phase. The exemplary operating temperatures and pressures set out hereinabove may facilitate efficient operation of the integrated recuperator and separator in this regard.

Embodiments of the present disclosure facilitate an at least partially closed circuit process whereby a mass of natural gas extracted from the subsurface reservoir is balanced by a mass of carbon dioxide injected back into the subsurface reservoir. The mass balance can be fine-tuned by adjusting the mass of water discharged to drainage from the heat recuperator and steam condenser and/or the carbon dioxide and water separator, or from the integrated recuperator and separator.

By installing a system of embodiments of the present disclosure at or close to a subsurface natural gas reservoir, for example on an offshore platform or platforms, it is not necessary to transport natural gas from the reservoir to a remote power plant, nor is it necessary to transport produced carbon dioxide back to the subsurface natural gas reservoir for sequestration. Instead, extraction and sequestration can take place in situ.

Embodiments of the present disclosure may facilitate the flexible generation of substantially carbon-neutral, dispatchable electricity. The method and system may be stopped and started as required, and does not require a long run-in time or shut-down time. Existing natural gas-fueled turbine generator systems may require several hours of run-in time before they are operating at useful efficiencies, or may require several hours of shut-down time before they can be started up again. This means that it can be difficult or impossible to generate electricity flexibly on demand. Embodiments of the present disclosure may be configured to generate electricity economically for periods of as little as 30 minutes at little or no advance notice. Since electricity is often traded in 30 minute periods when supplying an electricity grid, this can be highly beneficial for suppliers of electrical power.

### BRIEF DESCRIPTION OF THE DRAWINGS

Embodiments of the invention are further described hereinafter with reference to the accompanying drawings, in which:

FIG. 1 is a schematic outline of a system for natural gas production and oxy-fuel combustion of natural gas to generate electrical power;

FIG. 2 is a schematic outline of a system for oxy-fuel combustion of hydrogen to generate electrical power;

FIG. 3 shows a first view of an integrated recuperator and separator that may be implemented in the system of FIG. 1;

FIG. 3;

FIG. 4 shows a second view of the integrated recuperator and separator of FIG. 5 shows detail A of FIG. 4;

FIG. 6 shows detail B of FIG. 4;

FIG. 7 is a schematic outline of a system of an embodiment of the present disclosure.

### DETAILED DESCRIPTION

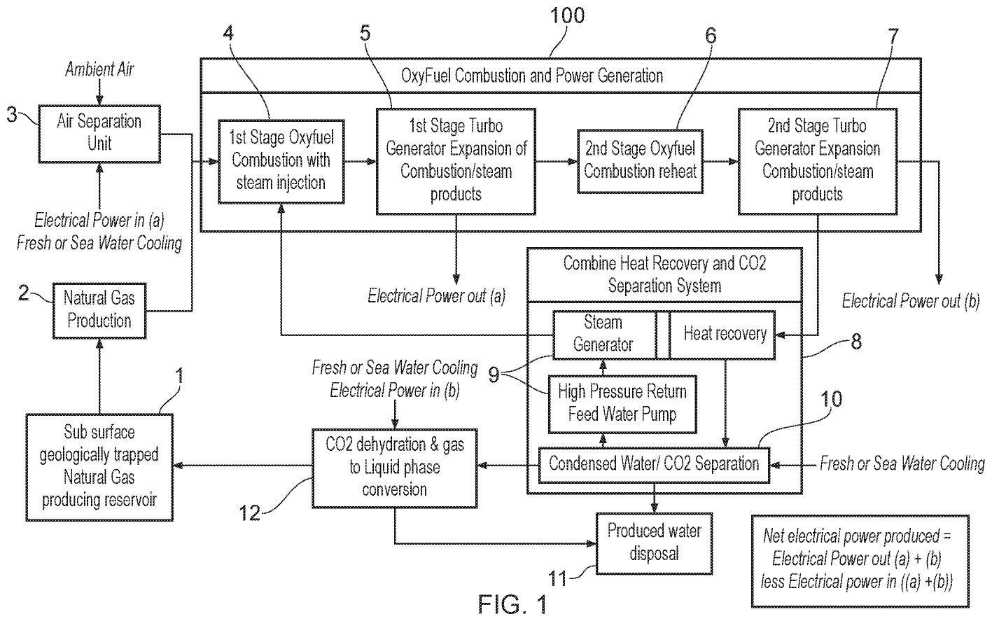

FIG. 1 shows a schematic outline of a system for natural gas production and oxy-fuel combustion with direct steam injection and expansion through an electrical turbine generator incorporating full carbon dioxide capture and underground storage.

The system is configured for installation above or close to a subsurface natural gas producing reservoir 1, which may be a naturally-occurring store of geologically-trapped natural gas. The installation may be onshore or offshore. Where the installation is offshore, the water required by the system may be obtained from seawater.

Natural gas is extracted from the reservoir 1 by way of known extraction techniques, for example by way of a well head and ancillary equipment. The natural gas may be processed as required to remove contaminants such as sand or water. The natural gas is received into the system from the subsurface reservoir 1 at the production well head at any pressure above 100 kPa (1 bar) and at temperatures between −20° C. and +60° C. to be compressed at processing module 2 to between 2 Mpa (20 bar) and 7 MPa (70 bar) nominal operating pressures and consequential respective gas temperatures resulting from adiabatic compression.

An oxygen separation module 3 takes ambient air and extracts oxygen from the ambient air to provide a high purity oxygen feed with an oxygen content of at least 90 vol %, preferably at least 95 vol %, ideally at least 98 vol %. The ambient air may be at atmospheric pressure of around 100 kPa (1 bar) and a temperature of −40° C. to +60° C. The oxygen separation module 3 can be a cryogenic air separation module that separates oxygen by a fractionation process. By-products of nitrogen, argon and other trace gases produced by the cryogenic separation process may be used as a heat sink to pre-cool compressed ambient air prior to entering the fractionation process, and the warmed by-products can subsequently be released to atmosphere. The oxygen separation module 3 may make use of freshwater or seawater for cooling, and electrical power. The oxygen produced by cryogenic fractional separation is in the liquid phase and at a pressure of around 100 kPa (1 bar), and will therefore be at a temperature of around −183° C. The liquid oxygen is then pumped to a pressure of 2 MPa (20 bar) to 7 MPa (70 bar). The liquid oxygen may be used as a cold source for pre-cooling air being drawn into the cryogenic air separation module 3, and the temperature of the pressurised oxygen may therefore rise, in some cases up to ambient air temperatures. The increase in temperature may be sufficient to vaporise the pressurised liquid oxygen into the gas phase prior to combustion. It is important to note, however, that the main pressurisation, to a pressure of 2 MPa (2 bar) to 7 MPa (7 bar), takes place while the oxygen is in the liquid phase, and is achieved by pumping.

A turbine system 100 comprises an oxy-fuel gas turbine generator provided with an oxygen feed, a fuel feed and a steam feed. The first stage oxy-fuel gas turbine generator includes a combustion chamber 4. Oxygen from the oxygen separation module 3 and natural gas from the natural gas processing module 2 are pumped in the liquid phase to the required pressure, for example 2 MPa (2 bar) to 7 MPa (7 bar). The liquid oxygen and liquid natural gas are vaporised and injected into the combustion chamber 4 and combusted in the presence of steam. The natural gas fuel is injected into the combustion chamber 4 at any temperature above 0° C. and at a pressure between 2 Mpa (20 bar) and 7 MPa (70 bar). The oxygen is injected into the combustion chamber 4 at a pressure between 2 Mpa (20 bar) and 7 MPa (70 bar). The temperature of the oxygen at the point of injection into the combustion chamber 4 will be somewhere between −183° C. and ambient air temperature depending on prior processing and storage, as well as on specific prevailing conditions such as volumetric flow rates, ramp rates of the flow, and system latencies of any heat exchangers employed in upstream cryogenic processes for oxygen production. The oxygen and natural gas are mixed and combusted in an oxy-fuel combustion process to provide a heat source through combustion to further mix with injected steam of between 2 MPa (20 bar) and 7 MPa (70 bar) and between 220° C. and 400° C. for the purpose of both moderating fluid temperatures and increasing fluid density. Fluid conditions can be maintained below allowable first stage expander turbine inlet temperatures of 1350° C. at 7 MPa (70 bar), depending on actual fluid density and flow rates. The combustion exhaust fluids are presented to a first stage expander turbine section 5 at a temperature range of between 845° C. and 1350° C. and pressures from 2 MPa (20 bar) to 7 MPa (70 bar) to undertake adiabatic expansion to pressures from 600 kPa (6 bar) and 1 MPa (10 bar) and temperatures between 380° C. and 750° C. The exhaust fluids expand through one or more turbine rotors in the first stage expander turbine section 5 to produce work to drive an asynchronous, grid connected electrical generator and generate electrical power at (a).

The exhaust fluids from the first stage expander turbine section 5 are passed to a second stage oxy-fuel combustion reheater 6 to reheat the exhaust fluids. The reheated exhaust fluids may have temperatures between 525° C. and 1350° C. at pressures between 600 kPa (6 bar) and 1M Pa (10 bar).

The reheated exhaust fluids are presented to a second stage expander turbine section 7 to undertake adiabatic expansion of the exhaust fluids to a pressure of around 120 kPa (1.2 bar) and temperatures between 320° C. and 650° C. The exhaust fluids expand through one or more turbine rotors in the second stage expander turbine section 7 to produce work to drive an asynchronous, grid connected electrical generator and generate electrical power at (b).

Exhaust fluids from the second stage expander turbine section 7 are passed to an integrated system of heat exchangers, heat recuperators, condensers and multiphase separators 8 that condenses water within the exhaust fluids in order to extract gas phase carbon dioxide from the exhaust fluids through two phase separation. At entry to the integrated system 8, heat is recovered from the exhaust fluids through a heat exchanger component to heat recirculated water to temperatures between 225° C. and 400° C. The heated recirculated water, in the form of steam, is pumped to a pressure of 2 MPa (20 bar) and 7 MPa (70 bar), indicated generally at 9. The resultant preheated steam is presented to the combustion chamber 4 of the turbine system 100.

Fresh water or seawater at temperatures between 5° C. and 30° C. is used as a tertiary cooling source for the exhaust fluids to achieve fluid temperatures of between 60° C. and 95° C. prior to separation of carbon dioxide in a two-phase separator 10. The cooled exhaust fluids are passed through the two-phase separator 10 to separate the carbon dioxide and water components. A proportion of the produced water is recirculated to the combustion chamber 4 and the remainder is degassed from any residual carbon dioxide and disposed of at 11.

The produced carbon dioxide, at concentrations from 92 vol % and 96 vol %, is compressed through a multi-stage process and cooled with fresh or seawater to dehydrate the carbon dioxide and to condense to a liquid or supercritical dense phase at module 12. Compressors are electrically driven using power generated by the turbine system, and residual produced water is separated at each of the compression stages and drained at 11.

The liquid or supercritical phase carbon dioxide produced by module 12 is discharged into the same subsurface reservoir 1 from which the natural gas providing fuel for the oxy-fuel combustion process is extracted. This may be done through injection wells that are separate from the extraction wells. The carbon dioxide remains in the dense liquid or supercritical phase and has the effect of increasing reservoir pressure over time which assists natural gas production through re-pressurisation of the reservoir 1.

In this way, embodiments of the disclosure provide a system whereby electrical power can be obtained from oxy-fuel combustion of natural gas extracted from a subsurface reservoir 1, and carbon dioxide produced by the oxy-fuel combustion process can be sequestered back into the reservoir 1. This has the dual purpose of both sequestering the carbon dioxide so as to reduce or avoid greenhouse emissions, and also re-pressurising the reservoir 1 so as to facilitate natural gas extraction. Additionally, the oxy-fuel combustion process produces little or no NOₓ pollution, which is also of environmental benefit.

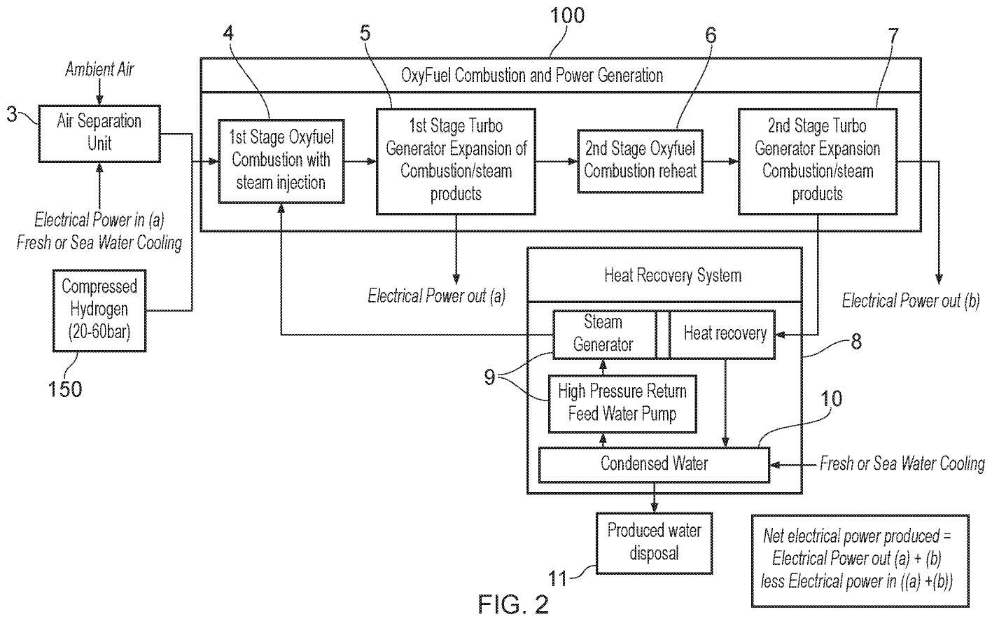

FIG. 2 shows a schematic outline of a system similar in some respects to that of FIG. 1, but configured to use hydrogen as a fuel rather than natural gas. Many of the elements of the system are the same as or substantially similar to those of FIG. 1, and are labelled accordingly. However, since hydrogen fuel is not extracted from natural subsurface reservoirs, and since oxy-fuel combustion of hydrogen does not generate carbon dioxide, these aspects of the FIG. 1 embodiment are omitted.

Compressed hydrogen, at a pressure of 2 MPa (20 bar) to 6 MPa (60 bar) is provided at 150. The temperature of the compressed hydrogen may be any appropriate temperature. The hydrogen is pumped in the liquid phase to the combustion chamber 4 as fuel.

An oxygen separation module 3 takes ambient air and extracts oxygen from the ambient air to provide a high purity oxygen feed with an oxygen content of at least 90 vol %, preferably at least 95 vol %, ideally at least 98 vol %. The ambient air may be at atmospheric pressure of around 100 kPa (1 bar) and a temperature of −40° C. to +60° C. The oxygen separation module 3 can be a cryogenic air separation module that separates oxygen by a fractionation process. By-products of nitrogen, argon and other trace gases produced by the cryogenic separation process may be used as a heat sink to pre-cool compressed ambient air prior to entering the fractionation process, and the warmed by-products can subsequently be released to atmosphere. The oxygen separation module 3 may make use of freshwater or seawater for cooling, and electrical power.

A turbine system 100 comprises an oxy-fuel gas turbine generator provided with an oxygen feed, a fuel feed and a steam feed. The first stage oxy-fuel gas turbine generator includes a combustion chamber 4. Oxygen from the oxygen separation module 3 and hydrogen from the hydrogen supply 150 are pumped in the liquid phase to the required pressure, for example 2 MPa (2 bar) to 7 MPa (7 bar). The liquid oxygen and liquid hydrogen are vaporised and injected into the combustion chamber 4 and combusted in the presence of steam. The hydrogen fuel is injected into the combustion chamber 4 at a pressure between 2 Mpa (20 bar) and 6 MPa (60 bar). The oxygen is injected into the combustion chamber 4 at a pressure between 2 Mpa (20 bar) and 7 MPa (70 bar). The temperature of the oxygen at the point of injection into the combustion chamber 4 will be somewhere between −183° C. and ambient air temperature depending on prior processing and storage, as well as on specific prevailing conditions such as volumetric flow rates, ramp rates of the flow, and system latencies of any heat exchangers employed in upstream cryogenic processes for oxygen production. The oxygen and hydrogen are mixed and combusted in an oxy-fuel combustion process to provide a heat source through combustion to further mix with injected steam of between 2 MPa (20 bar) and 7 MPa (70 bar) and between 220° C. and 400° C. for the purpose of both moderating fluid temperatures and increasing fluid density. Fluid conditions can be maintained below allowable first stage expander turbine inlet temperatures of 1350° C. at 7 MPa (70 bar), depending on actual fluid density and flow rates. The combustion exhaust fluids are presented to a first stage expander turbine section 5 at a temperature range of between 845° C. and 1350° C. and pressures from 2 MPa (20 bar) to 7 MPa (70 bar) to undertake adiabatic expansion to pressures from 600 kPa (6 bar) and 1 MPa (10 bar) and temperatures between 380° C. and 750° C. The exhaust fluids expand through one or more turbine rotors in the first stage expander turbine section 5 to produce work to drive an asynchronous, grid connected electrical generator and generate electrical power at (a).

The exhaust fluids from the first stage expander turbine section 5 are passed to a second stage oxy-fuel combustion reheater 6 to reheat the exhaust fluids. The reheated exhaust fluids may have temperatures between 525° C. and 1350° C. at pressures between 600 kPa (6 bar) and 1 MPa (10 bar).

The reheated exhaust fluids are presented to a second stage expander turbine section 7 to undertake adiabatic expansion of the exhaust fluids to a pressure of around 120 kPa (1.2 bar) and temperatures between 320° C. and 650° C. The exhaust fluids expand through one or more turbine rotors in the second stage expander turbine section 7 to produce work to drive an asynchronous, grid connected electrical generator and generate electrical power at (b).

Exhaust fluids from the second stage expander turbine section 7 are passed to an integrated heat recovery system 8 that condenses water within the exhaust fluids through two phase separation. At entry to the integrated system 8, heat is recovered from the exhaust fluids through a heat exchanger component to heat recirculated water to temperatures between 225° C. and 400° C. The heated recirculated water, in the form of steam, is pumped to a pressure of 2 MPa (20 bar) and 7 MPa (70 bar), indicated generally at 9. The resultant preheated steam is presented to the combustion chamber 4 of the turbine system 100. A proportion of the produced water is recirculated to the combustion chamber 4 and the remainder may be disposed of at 11.

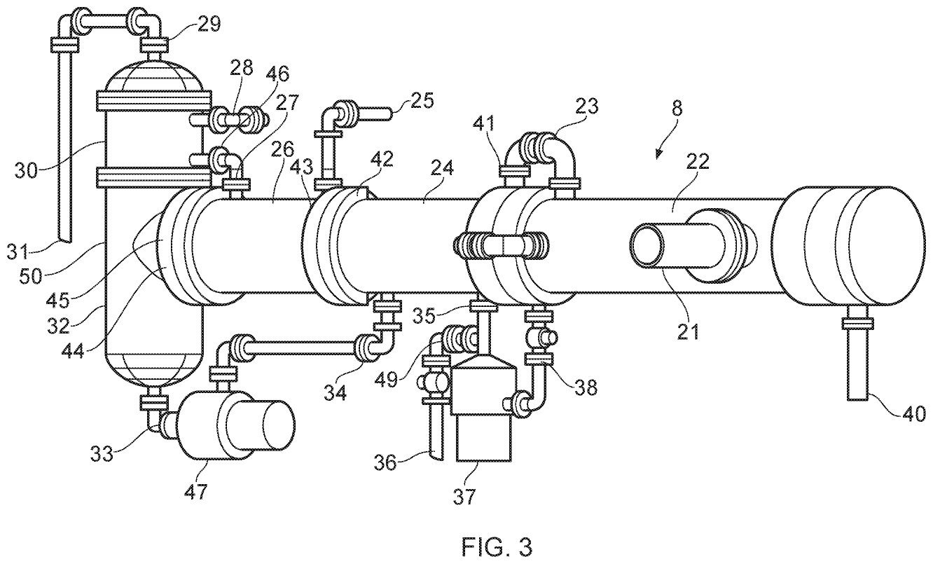

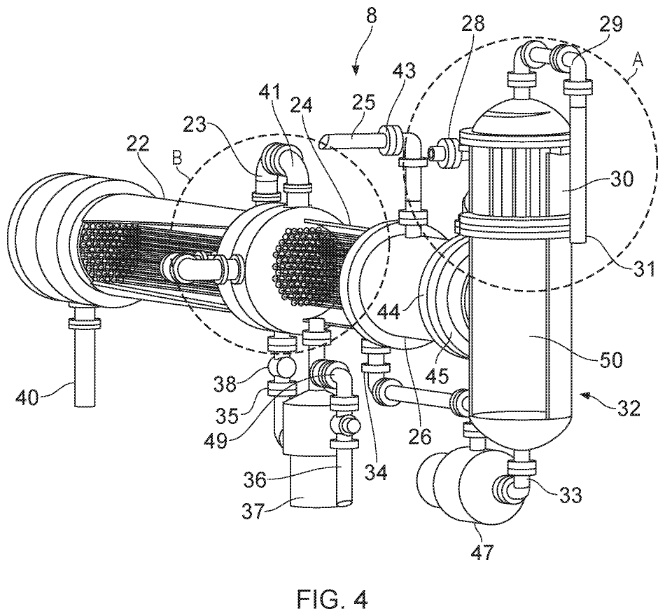

FIG. 3 shows an example of an integrated recuperator and separator 8 that may be implemented in the system of FIG. 1. The integrated recuperator and separator 8 comprises an evaporator heat exchanger 22 having an exhaust fluid inlet 21 and an exhaust fluid outlet 23, and a water inlet 38 and a steam outlet 40. The integrated recuperator and separator 8 further comprises an economiser heat exchanger 24 having an exhaust fluid inlet 41 connected to the exhaust fluid outlet 23 of the evaporator heat exchanger 22 and an exhaust fluid outlet 42, and a water inlet 34 and a water outlet 35, the water outlet 35 being connected to the water inlet 38 of the evaporator heat exchanger 22. The integrated recuperator and separator 8 further comprises a first stage condenser 26 having an exhaust fluid inlet 43 connected to the exhaust fluid outlet 42 of the economiser heat exchanger 24 and an exhaust fluid outlet 44, and a water inlet 27 and water outlet 25 (which may be connected to drainage). The integrated recuperator and separator 8 further comprises a second stage condenser and separator 32 having an exhaust fluid inlet 45 connected to the exhaust fluid outlet 44 of the first stage condenser 26, a separated carbon dioxide outlet 29, a separated water outlet 33 connected to the water inlet 34 of the economiser heat exchanger 24, a cooling water inlet 28 and a cooling water outlet 46, the cooling water outlet 46 connected to the water inlet 27 of the first stage condenser 26. A pump 47 is connected between the separated water outlet 33 of the second stage condenser and separator 32 and the water inlet 34 of the economiser heat exchanger 24. A pump 37 is connected between the water outlet 35 of the economiser heat exchanger 24 and the water inlet 38 of the evaporator heat exchanger 22. Control valves 49 at the water outlet 35 of the economiser heat exchanger 24 allow surplus water to be drained at 36.

The exhaust fluid inlet 21 of the evaporator heat exchanger 22 may be connected to the exhaust fluid outlet of the second stage expander turbine generator 7 of FIG. 1. The steam outlet 40 of the evaporator heat exchanger 22 may provide the steam feed for the combustion chamber 4 of the first stage oxy-fuel gas turbine generator of FIG. 1.

Increasing the mass density of the working fluid can improve the thermal energy efficiency of the oxy-fuel combustion driven turbine system of FIG. 1. Selection of the components of the fluid stream requires consideration of the compressibility of the components and any consequent latent energy effects through the process cycle for the working fluid. The integrated recuperator and separator 8 of FIG. 3 allows the use of water as a component of the working fluid in both liquid and steam phases and the management of latent energy losses arising from condensation and evaporation through the cycle with the use of a system of partially closed circuit evaporators, condensers and two phase separators.

With reference to FIG. 3, exhaust fluids comprising steam, carbon dioxide and trace components received from the second stage expansion turbine generator 7 of FIG. 1 are input at the exhaust fluid inlet 21 of the evaporator heat exchanger 22 at a temperature between 380° C. and 750° C. and a pressure of around 120 kPa (1.2 bar). The exhaust fluid inlet 21 is on the shell side of the evaporator shell and tube heat exchanger 22.

Preheated high pressure water at temperature of 65° C. to 95° C. and a pressure of 2 MPa (20 bar) to 7 MPa (70 bar) passed through the tube side water inlet 38 of the evaporator heat exchanger 22. High pressure saturated steam at a temperature of 225° C. to 400° C. and a pressure of 2 MPa (20 bar) to 7 MPa (70 bar) is output from the tube side steam outlet 40.

Exhaust fluids at a temperature of 150° C. to 275° C. and a pressure of around 110 kPa (1.1 bar) are transferred from the evaporator heat exchanger 22 shell side exhaust fluid outlet 23 to the tube side exhaust fluid inlet 41 of the economiser heat exchanger 24, as shown in more detail in FIGS. 3 and 5. The exhaust fluids exit the economiser heat exchanger 24 at tube side exhaust fluid outlet 42.

Exhaust fluids enter the tube side of first stage condenser 26 at tube side exhaust fluid inlet 43 from tube side exhaust fluid outlet 42 at a temperature of 55° C. to 65° C. and around 100 kPa (1 bar) pressure. Cooling water enters the shell side water inlet 27 of the first stage condenser 26 at a temperature of 15° C. to 45° C. and exits from the shell side cooling water outlet 25 at a temperature of 45° C. to 65° C. The cooling water output from cooling water outlet 25 can be drained, or may be discharged into the sea after appropriate drainage processing. Exhaust fluids exit the tube side exhaust fluid outlet 44 of the first stage condenser 26 at a temperature of 25° C. to 65° C. and a pressure of around 80 kPa (0.8 bar) to 90 kPa (0.9 bar).

Exhaust fluids consisting of liquid water, water vapour, carbon dioxide and trace components enter the exhaust fluid inlet 45 of the second stage condenser and separator 32 at a temperature of 25° C. to 65° C. and a pressure of around 80 kPa (0.8 bar) to 90 kPa (0.9 bar). A top portion 30 of the second stage condenser and separator 32 has a shell and tube configuration, while a main body 50 of the second stage condenser and separator 32 is configured as a largely empty vessel that may have horizontal baffles or trays to increase the dwell time of the condensed water so as to facilitate further separation of dissolved carbon dioxide. Cooling water at a temperature of 5° C. to 25° C. enters a top portion 30 of the second stage condenser and separator 32 at shell side cooling water inlet 28 and exits via shell side cooling water outlet 46 at a temperature of 15° C. to 45° C. before being passed to shell side cooling water inlet 27 of the first stage condenser 26.

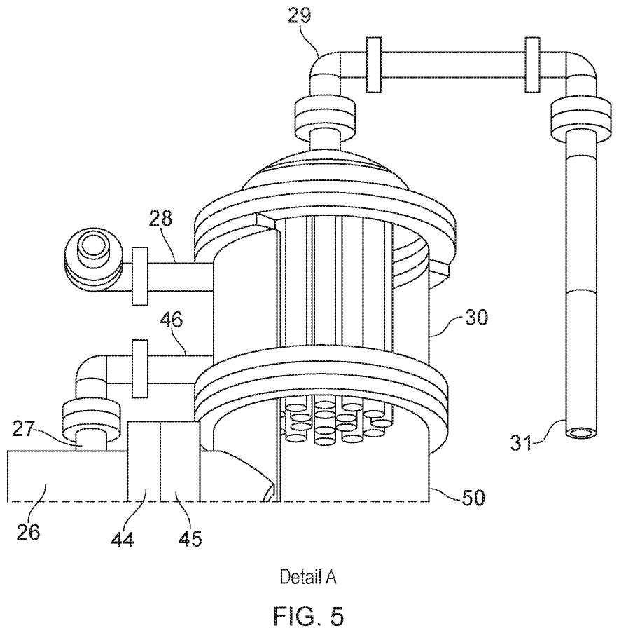

Carbon dioxide saturated with water vapour passes through the tube side of the top portion 30 of the second stage condenser and separator 32, resulting in condensed water returning to the main body 50 of the second stage condenser and separator 32. Separated carbon dioxide exits from the tube side separated carbon dioxide outlet 29 of the second stage condenser and separator at a temperature of 25° C. to 45° C. and a pressure of around 80 kPa (0.8 bar) to 90 kPa (0.9 bar). Details of the top portion 30 of the second stage condenser and separator 32 are shown in FIGS. 4 and 5.

Carbon dioxide and any exhaust gas trace components are transferred from separated carbon dioxide outlet 29 to a module 12 (in FIG. 1) by way of pipeline 31 in order to dry, compress and liquefy the carbon dioxide prior to sequestration in the subsurface reservoir 1.

Produced water is collected from the main body 50 of the second stage condenser and separator 32 through the separated water outlet 33 at a temperature of 25° C. to 65° C. and a pressure of around 80 kPa (0.8 bar) to 90 kPa (0.9 bar). Pump 47 is operable to pump the separated water to a pressure of around 200 kPa (2 bar) before transferring the pressurised water at a temperature of 25° C. to 65° C. to the shell side water inlet 34 of the economiser heat exchanger 24.

Preheated water at a temperature of 62° C. to 93° C. exits through the shell side water outlet 35 of the economiser heat exchanger 24 with flow managed by control valves 49 to split the flow rates between a recycled water return and surplus produced water disposal 36. Pump 37 is operable to pump recycled water to a pressure of 2 MPa (20 bar) to 7 MPa (70 bar) into the tube side water inlet 38 of the evaporator heat exchanger 22 at a temperature of 65° C. to 95° C. and a pressure of 2 MPa (20 bar) to 7 MPa (70 bar).

High pressure saturated steam at a temperature of 225° C. to 400° C. and a pressure of 2 MPa (20 bar) to 7 MPa (70 bar) is output from the tube side steam outlet 40 and fed to the combustion chamber 4 of the first stage oxy-fuel gas turbine generator as shown in FIG. 1.

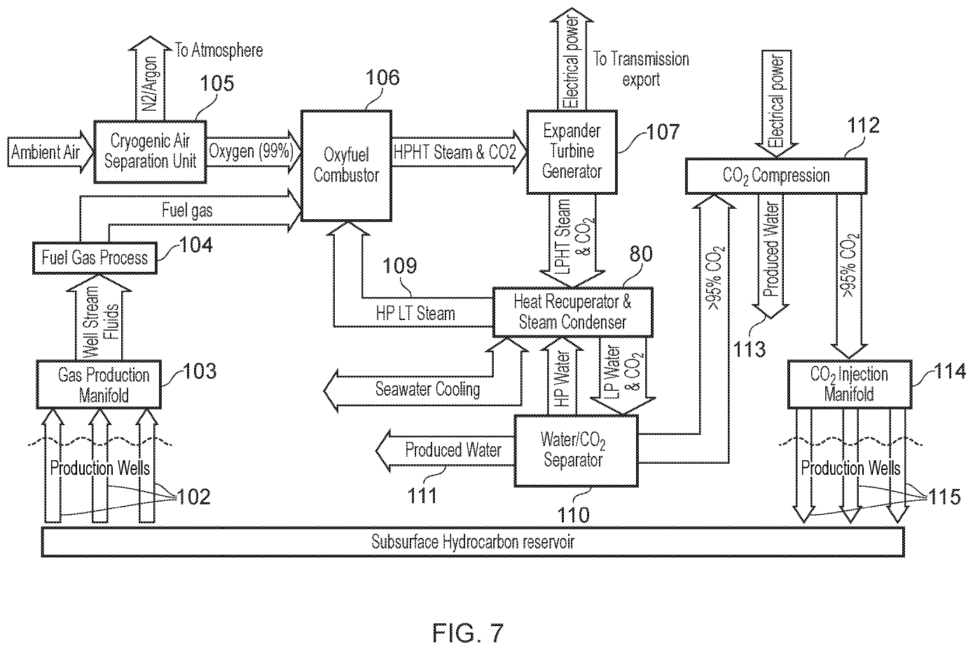

FIG. 7 shows a schematic outline of a system for power generation from oxy-fuel combustion of natural gas with carbon dioxide capture and sequestration.

The system is configured for installation above or close to a subsurface natural gas producing reservoir 101, which may be a naturally-occurring store of geologically-trapped natural gas. The installation may be onshore or offshore. Where the installation is offshore, the water required by the system may be obtained from seawater. Water required for start-up and initial steam injection may be demineralised seawater. Water required simply for cooling may be filtered seawater depending on the materials used in the heat exchangers.

Natural gas is extracted from the reservoir 101 by way of known extraction techniques, for example by way of production wells 102 and wellheads. The natural gas is received from the wellheads at a gas production manifold 103, and may be processed by way of a conventional fuel gas processor 104 to remove impurities such as sand and/or excess water.

The natural gas is received into the system from the subsurface reservoir 101 at the production well head at any pressure above 100 kPa (1 bar) and at temperatures between −20° C. and +60° C. to be compressed to between 2 Mpa (20 bar) and 7 MPa (70 bar) nominal operating pressures and consequential respective gas temperatures resulting from adiabatic compression.

An oxygen separation module 105 takes ambient air and extracts oxygen from the ambient air to provide a high purity oxygen feed with an oxygen content of at least 90 vol %, preferably at least 95 vol %, ideally at least 98 vol %. The ambient air may be at atmospheric pressure of around 100 kPa (1 bar) and a temperature of −40° C. to +60° C. The oxygen separation module 105 can be a cryogenic air separation module that separates oxygen by a fractionation process. By-products of nitrogen, argon and other trace gases produced by the cryogenic separation process may be used as a heat sink to pre-cool compressed ambient air prior to entering the fractionation process, and the warmed by-products can subsequently be released to atmosphere. The oxygen separation module 105 may make use of freshwater or seawater for cooling, and electrical power.

An oxy-fuel combustor 106 receives an oxygen feed from the oxygen separation module 105 and a fuel feed from the fuel gas processor 104, and combusts the fuel and oxygen in the presence of steam to generate combustion exhaust fluids. The oxygen and the natural gas are each pumped to a required pressure while in the liquid phase. Natural gas is injected into the oxy-fuel combustor 106 at any temperature above 0° C. and at a pressure between 2 Mpa (20 bar) and 7 MPa (70 bar). The oxygen feed is supplied by the oxygen separation module 105. The oxygen and natural gas are vaporised and injected into the oxy-fuel combustor 106 and combusted in an oxy-fuel combustion process to provide a heat source through combustion to further mix with injected steam of between 2 MPa (20 bar) and 7 MPa (70 bar) and between 220° C. and 400° C. for the purpose of both moderating fluid temperatures and increasing fluid density.

The combustion exhaust fluids are then presented to one or more turbine generators 107 for expansion through a plurality of turbine rotors to drive an electrical generator. Fluid conditions can be maintained below allowable first stage expander turbine inlet temperatures of 1350° C. at 7 MPa (70 bar), depending on actual fluid density and flow rates. The combustion exhaust fluids are presented to the turbine generator 107 at a temperature range of between 845° C. and 1350° C. and pressures from 2 MPa (20 bar) to 7 MPa (70 bar) to undertake adiabatic expansion.

Exhaust fluids from the turbine generator 107, at a pressure of around 120 kPa (1.2 bar) and temperatures between 320° C. and 650° C., are passed to a heat recuperator and steam condenser 80. The heat recuperator and steam condenser 80 cools the exhaust fluids to a temperatures of 60° C. to 95° C., and uses heat from the exhaust fluids to regenerate steam from water that is separated from the exhaust fluid in a carbon dioxide and water separator discussed in the following paragraphs.

The cooled exhaust fluids are passed to a carbon dioxide and water separator 110 in order to extract gas phase carbon dioxide from the exhaust fluids through two phase separation. Heat is recovered from the exhaust fluids through a heat exchanger component to heat recirculated water to temperatures between 225° C. and 400° C. The heated recirculated water, in the form of steam, is pumped to a pressure of 2 MPa (20 bar) and 7 MPa (70 bar), indicated generally at 109. The resultant preheated steam is recycled to the first stage oxy-fuel combustor 106.

Fresh or seawater at temperatures between 5° C. and 30° C. is used as a tertiary cooling source for the exhaust fluids to achieve fluid temperatures of between 60° C. and 95° C. prior to separation of carbon dioxide in the carbon dioxide and water separator 110. The cooled exhaust fluids are passed through the carbon dioxide and water separator 110 to separate the carbon dioxide and water components. A proportion of the produced water is recirculated to the oxy-fuel combustor 106 as steam, and the remainder is degassed from any residual carbon dioxide and disposed of at 111.

The produced carbon dioxide, at concentrations from 92 vol % and 96 vol %, is passed to carbon dioxide compressor 112, compressed through a multi-stage process and cooled with fresh or seawater to dehydrate the carbon dioxide and to condense to a liquid or supercritical dense phase. Compressors are electrically driven using power generated by the turbine generator 107, and residual produced water is separated at each of the compression stages and drained at 113.

The liquid or supercritical phase carbon dioxide produced by carbon dioxide compressor 112 is discharged into the same subsurface reservoir 101 from which the natural gas providing fuel for the oxy-fuel combustor 106 is extracted. This is done through carbon dioxide injection manifold 114 and injection wells 115 that are separate from the production wells 102. The carbon dioxide remains in the dense liquid or supercritical phase and has the effect of increasing reservoir pressure over time which assists natural gas production through re-pressurisation of the reservoir 101.

In this way, embodiments of the disclosure provide a system whereby electrical power can be obtained from oxy-fuel combustion of natural gas extracted from a subsurface reservoir 101, and carbon dioxide produced by the oxy-fuel combustion process can be sequestered back into the reservoir 101. This has the dual purpose of both sequestering the carbon dioxide so as to reduce or avoid greenhouse emissions, and also re-pressurising the reservoir 101 so as to facilitate natural gas extraction. Additionally, the oxy-fuel combustion process produces little or no NOₓ pollution, which is also of environmental benefit.

The heat recuperator and steam condenser 80 and the carbon dioxide and water separator 110 of FIG. 7 may be combined in an integrated recuperator and separator 8 as shown in FIG. 3 and implemented in the system of FIG. 7. The integrated recuperator and separator 8 comprises an evaporator heat exchanger 22 having an exhaust fluid inlet 21 and an exhaust fluid outlet 23, and a water inlet 38 and a steam outlet 40. The integrated recuperator and separator 8—further comprises an economiser heat exchanger 24 having an exhaust fluid inlet 41 connected to the exhaust fluid outlet 23 of the evaporator heat exchanger 22 and an exhaust fluid outlet 42, and a water inlet 34 and a water outlet 35, the water outlet 35 being connected to the water inlet 38 of the evaporator heat exchanger 22. The integrated recuperator and separator 80 further comprises a first stage condenser 26 having an exhaust fluid inlet 43 connected to the exhaust fluid outlet 42 of the economiser heat exchanger 24 and an exhaust fluid outlet 44, and a water inlet 27 and water outlet 25 (which may be connected to drainage). The integrated recuperator and separator 80 further comprises a second stage condenser and separator 32 having an exhaust fluid inlet 45 connected to the exhaust fluid outlet 44 of the first stage condenser 26, a separated carbon dioxide outlet 29, a separated water outlet 33 connected to the water inlet 34 of the economiser heat exchanger 24, a cooling water inlet 28 and a cooling water outlet 46, the cooling water outlet 46 connected to the water inlet 27 of the first stage condenser 26. A pump 47 is connected between the separated water outlet 33 of the second stage condenser and separator 32 and the water inlet 34 of the economiser heat exchanger 24. A pump 37 is connected between the water outlet 35 of the economiser heat exchanger 24 and the water inlet 38 of the evaporator heat exchanger 22. Control valves 49 at the water outlet 35 of the economiser heat exchanger 24 allow surplus water to be drained at 36.

The exhaust fluid inlet 21 of the evaporator heat exchanger 22 may be connected to the exhaust fluid outlet of the turbine generator 107 of FIG. 7. The steam outlet 40 of the evaporator heat exchanger 22 may provide the steam feed for the oxy-fuel combustor 106 of FIG. 7.

Increasing the mass density of the working fluid can improve the thermal energy efficiency of the oxy-fuel combustion driven turbine system of FIG. 7. Selection of the components of the fluid stream requires consideration of the compressibility of the components and any consequent latent energy effects through the process cycle for the working fluid. The integrated recuperator and separator 8 of FIG. 3 allows the use of water as a component of the working fluid in both liquid and steam phases and the management of latent energy losses arising from condensation and evaporation through the cycle with the use of a system of partially closed circuit evaporators, condensers and two phase separators.

With reference to FIG. 3, exhaust fluids comprising steam, carbon dioxide and trace components received from the turbine generator 107 of FIG. 7 are input at the exhaust fluid inlet 21 of the evaporator heat exchanger 22 at a temperature between 380° C. and 750° C. and a pressure of around 120 kPa (1.2 bar). The exhaust fluid inlet 21 is on the shell side of the evaporator shell and tube heat exchanger 22.

Preheated high pressure water at temperature of 65° C. to 95° C. and a pressure of 2 MPa (20 bar) to 7 MPa (70 bar) passed through the tube side water inlet 38 of the evaporator heat exchanger 22. High pressure saturated steam at a temperature of 225° C. to 400° C. and a pressure of 2 MPa (20 bar) to 7 MPa (70 bar) is output from the tube side steam outlet 40.

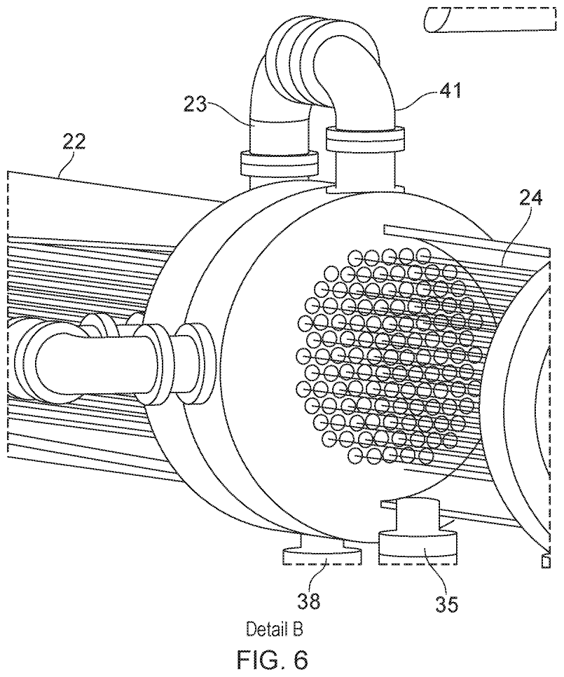

Exhaust fluids at a temperature of 150° C. to 275° C. and a pressure of around 110 kPa (1.1 bar) are transferred from the evaporator heat exchanger 22 shell side exhaust fluid outlet 23 to the tube side exhaust fluid inlet 41 of the economiser heat exchanger 24, as shown in more detail in FIGS. 4 and 6. The exhaust fluids exit the economiser heat exchanger 24 at tube side exhaust fluid outlet 42.

Exhaust fluids enter the tube side of first stage condenser 26 at tube side exhaust fluid inlet 43 from tube side exhaust fluid outlet 42 at a temperature of 55° C. to 65° C. and around 100 kPa (1 bar) pressure. Cooling water enters the shell side water inlet 27 of the first stage condenser 26 at a temperature of 15° C. to 45° C. and exits from the shell side cooling water outlet 25 at a temperature of 45° C. to 65° C. The cooling water output from cooling water outlet 25 can be drained, or may be discharged into the sea after appropriate drainage processing. Exhaust fluids exit the tube side exhaust fluid outlet 44 of the first stage condenser 26 at a temperature of 25° C. to 65° C. and a pressure of around 80 kPa (0.8 bar) to 90 kPa (0.9 bar).

Exhaust fluids consisting of liquid water, water vapour, carbon dioxide and trace components enter the exhaust fluid inlet 45 of the second stage condenser and separator 32 at a temperature of 25° C. to 65° C. and a pressure of around 80 kPa (0.8 bar) to 90 kPa (0.9 bar). A top portion 30 of the second stage condenser and separator 32 has a shell and tube configuration, while a main body 50 of the second stage condenser and separator 32 is configured as a largely empty vessel that may have horizontal baffles or trays to increase the dwell time of the condensed water so as to facilitate further separation of dissolved carbon dioxide. Cooling water at a temperature of 5° C. to 25° C. enters a top portion 30 of the second stage condenser and separator 32 at shell side cooling water inlet 28 and exits via shell side cooling water outlet 46 at a temperature of 15° C. to 45° C. before being passed to shell side cooling water inlet 27 of the first stage condenser 26.

Carbon dioxide saturated with water vapour passes through the tube side of the top portion 30 of the second stage condenser and separator 32, resulting in condensed water returning to the main body 50 of the second stage condenser and separator 32. Separated carbon dioxide exits from the tube side separated carbon dioxide outlet 29 of the second stage condenser and separator at a temperature of 25° C. to 45° C. and a pressure of around 80 kPa (0.8 bar) to 90 kPa (0.9 bar). Details of the top portion 30 of the second stage condenser and separator 32 are shown in FIGS. 4 and 5.

Carbon dioxide and any exhaust gas trace components are transferred from separated carbon dioxide outlet 29 to the carbon dioxide compressor 112 (in FIG. 7) by way of pipeline 31 in order to dry, compress and liquefy the carbon dioxide prior to sequestration in the subsurface reservoir 1.

Produced water is collected from the main body 50 of the second stage condenser and separator 32 through the separated water outlet 33 at a temperature of 25° C. to 65° C. and a pressure of around 80 kPa (0.8 bar) to 90 kPa (0.9 bar). Pump 47 is operable to pump the separated water to a pressure of around 200 kPa (2 bar) before transferring the pressurised water at a temperature of 25° C. to 65° C. to the shell side water inlet 34 of the economiser heat exchanger 24.

Preheated water at a temperature of 62° C. to 93° C. exits through the shell side water outlet 35 of the economiser heat exchanger 24 with flow managed by control valves 49 to split the flow rates between a recycled water return and surplus produced water disposal 36. Pump 37 is operable to pump recycled water to a pressure of 2 MPa (20 bar) to 7 MPa (70 bar) into the tube side water inlet 38 of the evaporator heat exchanger 22 at a temperature of 65° C. to 95° C. and a pressure of 2M Pa (20 bar) to 7 MPa (70 bar).

High pressure saturated steam at a temperature of 225° C. to 400° C. and a pressure of 2 MPa (20 bar) to 7 MPa (70 bar) is output from the tube side steam outlet 40 and fed to the oxy-fuel combustor 106 as shown in FIG. 7.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1. An integrated recuperator and separator comprising:
an evaporator heat exchanger having an exhaust fluid inlet and an exhaust fluid outlet, and a water inlet and a steam outlet;
an economiser heat exchanger having an exhaust fluid inlet connected to the exhaust fluid outlet of the evaporator heat exchanger and an exhaust fluid outlet, and a water inlet and a water outlet, the water outlet being connected to the water inlet of the evaporator heat exchanger;
a first stage condenser having an exhaust fluid inlet connected to the exhaust fluid outlet of the economiser heat exchanger and an exhaust fluid outlet, and a cooling water inlet and a cooling water outlet; and
a second stage condenser and separator having an exhaust fluid inlet connected to the exhaust fluid outlet of the first stage condenser, a separated carbon dioxide outlet, a separated water outlet connected to the water inlet of the economiser heat exchanger, a cooling water inlet and a cooling water outlet, the cooling water outlet connected to the cooling water inlet of the first stage condenser.

2. The integrated recuperator and separator as claimed in claim 1, further comprising a pump between the separated water outlet of the second stage condenser and separator and the water inlet of the economiser heat exchanger.

3. The integrated recuperator and separator as claimed in claim 1, further comprising a pump between the water outlet of the economiser heat exchanger and the water inlet of the evaporator heat exchanger.

4. The integrated recuperator and separator as claimed in claim 1, wherein the evaporator heat exchanger and the economiser heat exchanger are shell and tube heat exchangers, wherein the exhaust fluid inlet and exhaust fluid outlet of the evaporator heat exchanger are shell-side, and wherein the exhaust fluid inlet and exhaust fluid outlet of the economiser heat exchanger are tube-side.

5. The integrated recuperator and separator as claimed in claim 1, wherein the second stage condenser and separator is configured as a substantially vertical column having a main body and a top portion, wherein the cooling water inlet, the cooling water outlet and the separated carbon dioxide outlet are provided in the top portion.

6. The integrated recuperator and separator as claimed in claim 5, wherein the exhaust fluid inlet of the second stage condenser and separator is provided in a side wall of the main body.

7. The integrated recuperator and separator as claimed in claim 5, wherein the separated water outlet of the second stage condenser and separator is provided at a bottom of the main body.

8. The integrated recuperator and separator as claimed claim 5, wherein the top portion of the second stage condenser and separator has a tube and shell configuration, and wherein the cooling water inlet and cooling water outlet are shell-side, and wherein water is separated from carbon dioxide tube-side.

9. A turbine system comprising an oxy-fuel gas turbine generator comprising a combustion chamber section and an expander turbine section, a pumped liquid oxygen feed connected to the combustion chamber, a pumped liquid fuel feed connected to the combustion chamber, and a steam feed connected to the combustion chamber, wherein oxygen and fuel are injected into and combusted in the combustion chamber in the presence of steam, and exhaust fluids from the combustion chamber are expanded through the expander turbine section to drive an electrical generator, wherein water and/or steam from the exhaust fluids from the expander turbine section is separated and recirculated as steam to the steam feed of the combustion chamber by way of an integrated recuperator and separator comprising: an evaporator heat exchanger having an exhaust fluid inlet connected to an exhaust fluid outlet of the oxy-fuel gas turbine generator and an exhaust fluid outlet, and a water inlet and a steam outlet connected to the steam feed of the combustion chamber; an economiser heat exchanger having an exhaust fluid inlet connected to the exhaust fluid outlet of the evaporator heat exchanger and an exhaust fluid outlet, and a water inlet and a water outlet, the water outlet being connected to the water inlet of the evaporator heat exchanger; a first stage condenser having an exhaust fluid inlet connected to the exhaust fluid outlet of the economiser heat exchanger and an exhaust fluid outlet, and a cooling water inlet and a cooling water outlet; and a second stage condenser and separator having an exhaust fluid inlet connected to the exhaust fluid outlet of the first stage condenser, a separated carbon dioxide outlet, a separated water outlet connected to the water inlet of the economiser heat exchanger, a cooling water inlet and a cooling water outlet, the cooling water outlet connected to the cooling water inlet of the first stage condenser.

10. The turbine system as claimed in claim 9, wherein the oxy-fuel gas turbine generator further comprises a combustion reheater to reheat exhaust fluids from the expander turbine section and an additional expander turbine section to expand exhaust fluids from the combustion reheater to drive the electrical generator and/or an additional electrical generator.

11. The turbine system as claimed in claim 9, wherein the pumped liquid oxygen feed is supplied by a cryogenic air separator.

12. The turbine system as claimed in claim 9, wherein the fuel is a hydrocarbon; and wherein the fuel feed is connected to a subsurface natural gas reservoir and wherein carbon dioxide separated from the exhaust fluids of the oxy-fuel gas turbine generator is condensed and returned to the subsurface natural gas reservoir.

13. (canceled)

14. The turbine system as claimed in claim 12, further comprising a compressor module comprising at least one compressor configured to condense the separated carbon dioxide to a liquid or supercritical phase before return to the subsurface natural gas reservoir.

15. (canceled)

16. An oxy-fuel gas turbine generator comprising a combustion chamber section and an expander turbine section, a pumped liquid oxygen feed connected to the combustion chamber, a pumped liquid fuel feed connected to the combustion chamber, and a steam feed connected to the combustion chamber, wherein oxygen and fuel are injected into and combusted in the combustion chamber in the presence of steam, and exhaust fluids from the combustion chamber are expanded through the expander turbine section to drive an electrical generator, wherein water from the exhaust fluids from the expander turbine section is separated and recirculated as steam to the steam feed of the combustion chamber.

17. The oxy-fuel gas turbine generator as claimed in claim 16, further comprising a combustion reheater to reheat exhaust fluids from the expander turbine section and an additional expander turbine section to expand exhaust fluids from the combustion reheater to drive the electrical generator and/or an additional electrical generator.

18. The oxy-fuel gas turbine generator as claimed in claim 16, wherein the pumped liquid oxygen feed is supplied by a cryogenic air separator.

19. The oxy-fuel gas turbine generator as claimed in claim 16, wherein the fuel is a hydrocarbon, and wherein the liquid fuel feed is connected to a subsurface natural gas reservoir and wherein carbon dioxide separated from the exhaust fluids of the oxy-fuel gas turbine generator is condensed and returned to the subsurface natural gas reservoir.

20. (canceled)

21. The oxy-fuel gas turbine generator as claimed in claim 19, further comprising a compressor module comprising at least one compressor configured to condense the separated carbon dioxide to a liquid or supercritical phase before return to the subsurface natural gas reservoir.

22. (canceled)

23. A method of separating carbon dioxide from water in turbine exhaust fluids, wherein:
i) the turbine exhaust fluids are passed through an evaporator heat exchanger having an exhaust fluid inlet and an exhaust fluid outlet, and a water inlet and a steam outlet;
ii) the turbine exhaust fluids are then passed through an economiser heat exchanger having an exhaust fluid inlet connected to the exhaust fluid outlet of the evaporator heat exchanger and an exhaust fluid outlet, and a water inlet and a water outlet, the water outlet being connected to the water inlet of the evaporator heat exchanger;
iii) the turbine exhaust fluids are then passed through a first stage condenser having an exhaust fluid inlet connected to the exhaust fluid outlet of the economiser heat exchanger and an exhaust fluid outlet, and a cooling water inlet and a cooling water outlet;
iv) the turbine exhaust fluids are then passed through a second stage condenser and separator having an exhaust fluid inlet connected to the exhaust fluid outlet of the first stage condenser, a separated carbon dioxide outlet, a separated water outlet connected to the water inlet of the economiser heat exchanger, a cooling water inlet and a cooling water outlet, the cooling water outlet connected to the cooling water inlet of the first stage condenser; and
v) separated carbon dioxide is extracted by way of the separated carbon dioxide outlet.

24.-53. (canceled)

54. A method of electrical power generation, wherein:
i) liquid oxygen and liquid fuel are pumped to a predetermined pressure, vaporised and combusted in a combustion chamber of an oxy-fuel gas turbine generator in the presence of steam;
ii) exhaust fluids from the combustion chamber are expanded through an expander turbine section of the oxy-fuel gas turbine generator so as to drive an electrical generator; and
iii) water from exhaust fluids from the oxy-fuel gas turbine generator is separated and recirculated as steam to the combustion chamber.

55. The method according to claim 54, wherein in step iii):
iv) exhaust fluids from the oxy-fuel gas turbine generator are passed through an evaporator heat exchanger having an exhaust fluid inlet and an exhaust fluid outlet, and a water inlet and a steam outlet;
v) the exhaust fluids are then passed through an economiser heat exchanger having an exhaust fluid inlet connected to the exhaust fluid outlet of the evaporator heat exchanger and an exhaust fluid outlet, and a water inlet and a water outlet, the water outlet being connected to the water inlet of the evaporator heat exchanger;
vi) the exhaust fluids are then passed through a first stage condenser having an exhaust fluid inlet connected to the exhaust fluid outlet of the economiser heat exchanger and an exhaust fluid outlet, and a cooling water inlet and a cooling water outlet;
vii) the exhaust fluids are then passed through a second stage condenser and separator having an exhaust fluid inlet connected to the exhaust fluid outlet of the first stage condenser, a separated carbon dioxide outlet, a separated water outlet connected to the water inlet of the economiser heat exchanger, a cooling water inlet and a cooling water outlet, the cooling water outlet connected to the cooling water inlet of the first stage condenser;
viii) separated carbon dioxide is extracted by way of the separated carbon dioxide outlet; and
ix) steam from the steam outlet of the evaporator heat exchanger in step iv) is recirculated and provided to the combustion chamber of the oxy-fuel gas turbine generator as the steam in step i).

56. The method according to claim 54, wherein the exhaust fluids from the expander turbine section are reheated in a combustion reheater and subsequently further expanded through an additional expander turbine section so as to drive the electrical generator and/or a further electrical generator.

57. The method according to claim 54, wherein the pumped liquid oxygen feed is supplied by a cryogenic air separator.

58. The method according to claim 54, wherein the fuel is a hydrocarbon; and wherein the fuel is extracted from a subsurface natural gas reservoir and wherein carbon dioxide separated from the exhaust fluids of the oxy-fuel gas turbine generator is condensed and returned to the subsurface natural gas reservoir.

59. The method according to claim 58, wherein the separated carbon dioxide is compressed to a liquid or supercritical phase before being returned to the subsurface natural gas reservoir by pumping.
